(19) United States
(12) Patent Application Publication
(10) Pub. No.: US 2025/0103188 A1
(43) Pub. Date: Mar. 27, 2025

(54) COMBINING CONTENT ITEMS IN A SHARED CONTENT COLLECTION

(71) Applicant: Snap Inc., Santa Monica, CA (US)

(72) Inventors: Andrew Grosvenor Cooper, Los Angeles, CA (US); Christie Marie Heikkinen, Sherman Oaks, CA (US); Neil Tagare, New York, NY (US); David Phillip Taitz, Los Angeles, CA (US)

(21) Appl. No.: 18/725,071

(22) PCT Filed: Dec. 29, 2022
(86) PCT No.: PCT/US2022/082542

§ 371 Date: Jun. 27, 2024

Related U.S. Application Data
(60) Provisional application No. 63/365,167, filed on May 23, 2022.
(60) Provisional application No. 63/295,329, filed on Dec. 30, 2021.
(60) Provisional application No. 63/295,338, filed on Dec. 30, 2021.

(51) Int. Cl. G06F 3/0484; G06F 3/0482

(52) U.S. Cl. CPC G06F 3/0484; G06F 3/0482

(57) ABSTRACT

A content collection is shared between a first user and a second user. A content collection interface is presented on a second user device of the second user. The content collection interface enables the second user to navigate the shared content collection. The shared content collection includes a first content item. Responsive to receiving, from the second user device, an indication of a first combination selection, a second content item is accessed and the second user is enabled to combine the first content item with the second content item to create a first combined content item. Responsive to receiving, from the second user device, an indication of a first content addition selection, the first combined content item is stored in association with the shared content collection. The first combined content item is presented within the content collection interface on a first user device of the first user.

### CLAIM OF PRIORITY

This application claims the benefit of priority to U.S. Provisional Application Ser. No. 63/295,329, filed on Dec. 30, 2021, U.S. Provisional Application Ser. No. 63/295,338, filed on Dec. 30, 2021, and U.S. Provisional Application Ser. No. 63/365,167, filed on May 23, 2022, each of which is incorporated herein by reference in its entirety.

### BACKGROUND

Media applications provide for the exchange of media content between users. For example, a media application in the form of a messaging application allows a user to exchange content items (e.g., text, images, video, and combinations thereof) with one or more other users.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system, according to some examples, that has both client-side and server-side functionality.

FIG. 3 is a diagrammatic representation of a data structure as maintained in a database, according to some examples.

FIG. 4 is a diagrammatic representation of a message, according to some examples.

FIG. 5 is an interaction diagram illustrating a process for providing shared content collections within an interaction system, in accordance with some examples.

FIG. 6 is an interaction diagram illustrating a process for combining and sharing content items in a shared content collection within an interaction system, in accordance with some examples.

FIG. 7 is a user interface diagram illustrating a user interface corresponding to a user profile, including an interface element for creating a shared content collection, in accordance with some examples.

FIG. 8 is a user interface diagram illustrating a user interface for selecting between creating a private shared content collection or a shared content collection, in accordance with some examples.

FIG. 9 is a user interface diagram illustrating a user interface for selecting users to associate with a shared content collection, in accordance with some examples.

FIG. 10 is a user interface diagram illustrating a user interface corresponding to a user profile of a creating user of a shared content collection, in accordance with some examples.

FIG. 11 is a user interface diagram illustrating a user interface for selecting to view a shared content collection, in accordance with some examples.

FIG. 12 is a user interface diagram illustrating a content collection interface for viewing a shared content collection, according to some examples.

FIG. 13 is a user interface diagram illustrating a content collection interface for viewing a shared content collection, including an action menu, according to some examples.

FIG. 14 is a user interface diagram illustrating a remix camera interface for creating a combined content item, according to some examples.

FIG. 15 is a user interface diagram illustrating part of a user interface for presenting a user prompt, according to some examples.

FIG. 16 is a user interface diagram illustrating a content collection interface for viewing a combined content item in a shared content collection, according to some examples.

FIG. 17 is a user interface diagram illustrating a content collection interface for viewing a shared content collection, according to some examples.

FIG. 18 is a user interface diagram illustrating a remix camera interface for creating a combined content item, according to some examples.

FIG. 19 is a user interface diagram illustrating a remix camera interface for creating a combined content item, according to some examples.

FIG. 20 is a flowchart illustrating aspects of a method for creating and sharing combined content items in a shared content collection, in accordance with some examples.

FIG. 21 is a flowchart illustrating aspects of a method for creating and sharing combined content items in a shared content collection, in accordance with some examples.

FIG. 22 illustrates a system including a head-wearable apparatus, according to some examples.

FIG. 23 is a diagrammatic representation of a machine in the form of a computer system within which a set of instructions may be executed to cause the machine to perform any one or more of the methodologies discussed herein, according to some examples.

FIG. 24 is a block diagram showing a software architecture within which examples may be implemented.

FIG. 25 is a flowchart for an access-limiting process, according to some examples.

### DETAILED DESCRIPTION

An interaction system typically allows users to exchange content items (e.g., messages, images and/or video) with one another. As described herein, an interaction system may include content feeds for presenting content collections, where each content collection includes one or more content items.

Disclosed examples provide for an interaction system that allows a first user to create a content collection including one or more content items. The interaction system provides for the first user to share the content collection with one or more second user(s) selected by the first user. In this way, each of the first user and second user(s) are associated with the content collection. By virtue of being associated with the content collection, each of the first user and the second user(s) is able to view the content collection, and to add content (e.g., additional content items) to the content collection. The content may include a combined content item created by one of the users, e.g., using an existing content item in the shared content collection as a base item. The interaction system may enable such combined content items to be shared with the first user and second user(s).

In addition, each of the first user and second user(s) may be permitted to share the content collection with one or more selected third user(s). A third user may also be permitted to create a combined content item and to share the combined content item with the other members of the shared content collection.

### Networked Computing Environment

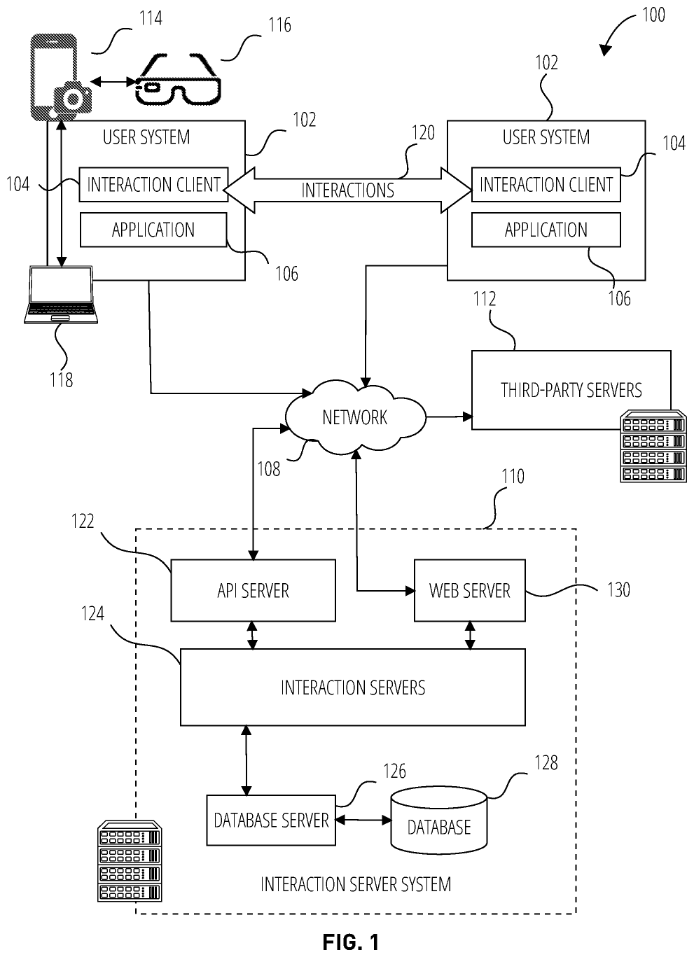

FIG. 1 is a block diagram showing an example interaction system 100 for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

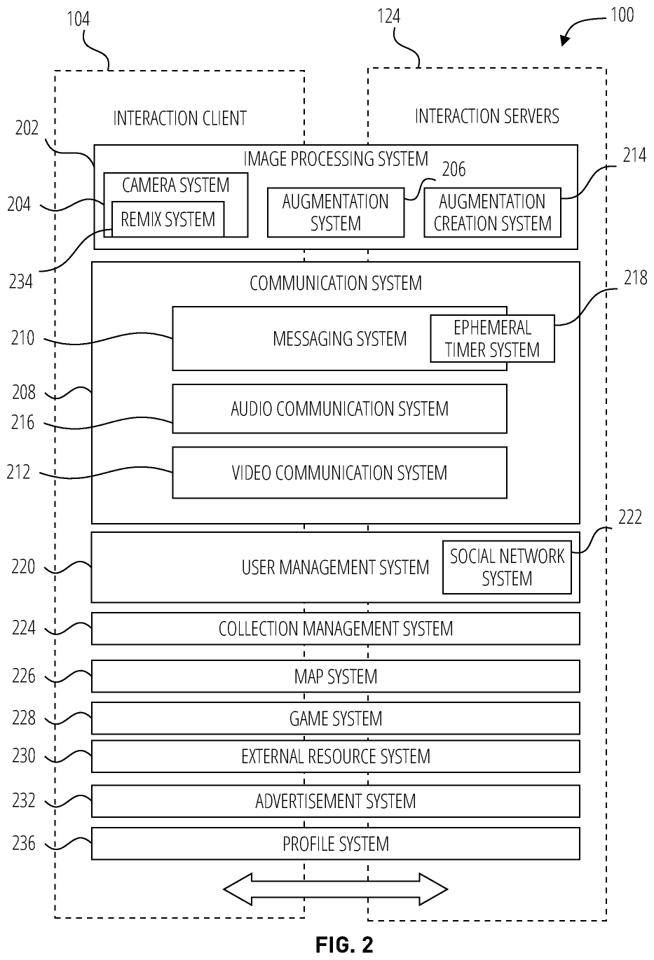

The interaction servers 124 host multiple systems and subsystems, described below with reference to FIG. 2.

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The camera system 204 includes a number of subsystems, including a remix system 234 that enables users of the interaction system 100 to “remix” multiple content items to create a combined content item. For example, using the remix system 234, a user, when viewing a collection of content items of one or more users of the interaction system 100, can combine a content item with a selected further content item (e.g., an image or video captured by the user, or an image or video selected by the user from a media library or file storage) to create a combined content item. The combined content item may, in some examples, also include audio content from the (original) content item used as a base item to create the combined content item. The remix system 234 provides various tools to enable a user to creatively combine content items, such tools including an augmentation tool and/or a layout tool, using which a relative layout of a first content item and a second content item (or more than two content items) can be defined and specified.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 2202 of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes a social network system 222 that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, a curation interface enables an event organizer to curate a collection of content relating to a specific event (e.g., delete inappropriate content or redundant messages). Additionally, the collection management system 224 employs machine vision (or image recognition technology) and content rules to curate a shared content collection automatically. In certain examples, compensation may be paid to a user to include user-generated content into a collection. In such cases, the collection management system 224 operates to automatically make payments to such users to use their content.

A map system 226 provides various geographic location functions and supports the presentation of map-based media content and messages by the interaction client 104. For example, the map system 226 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 228 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 230 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 232 operationally enables the purchasing of advertisements by third parties for presentation to end-users via the interaction clients 104 and also handles the delivery and presentation of these advertisements.

The profile system 236 implements various functions for maintaining profiles with respect to the interaction system 100. The profile data maintained by the profile system 236 may be selectively used and presented to other users of the interaction system 100, based on privacy settings specified by a particular entity.

From the perspective of an individual user, the profile system 236 provides for maintaining and presenting one or more of a self profile (e.g., “my profile”), friendship profiles, group profiles and public profiles. In one or more examples, a self profile corresponds to the individual user's own information in the interaction system 100 such as a user name, telephone number, address, settings (e.g., notification and privacy settings), and/or a user-selected avatar representation (or collection of such avatar representations).

In one or more examples, a friendship profile, or connection profile, includes information that is common to two users. Such information may include message content, such as but not limited to, images, videos, audio files, attachments, and messages (e.g., text-based messages), with any corresponding annotation data, exchanged within one or more message thread(s) with respect to the two users (e.g., friends/connections). A group profile includes information similar to that of a friend profile, and applies to a group of users (e.g., 2 or more users).

In one or more examples, a public profile provides for maintaining and presenting information associated with an entity. For example, an entity associated with a public profile may be a publisher such as a merchant, business, social media influencer and/or advertiser. The entity may create a public profile to showcase their content to other users (e.g., all users) of the interaction system 100, instead of being limited to friends/connections (e.g., in association with friend profiles). Moreover, the public profile provides for other users to select to subscribe to content provided by the entity (e.g., via a subscription button). For example, such content may be presented, along with other content from others, within a content feed provided by the interaction system 100.

### Data Architecture

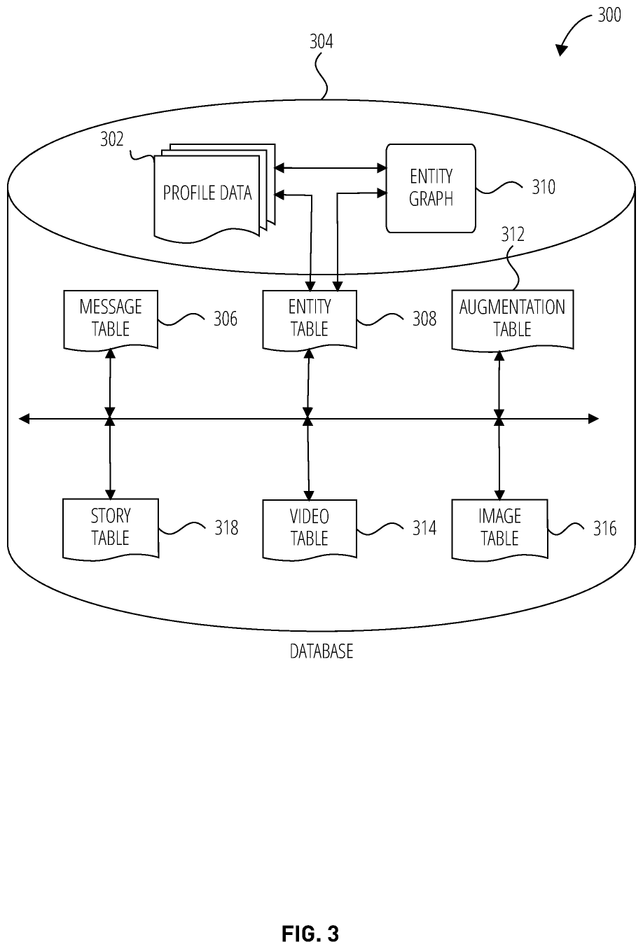

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. The terms “friend” and “contact” are used herein to indicate that two users of the interaction system 100 have a bidirectional relationship, as opposed to a unidirectional relationship.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of shared content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Data Communications Architecture

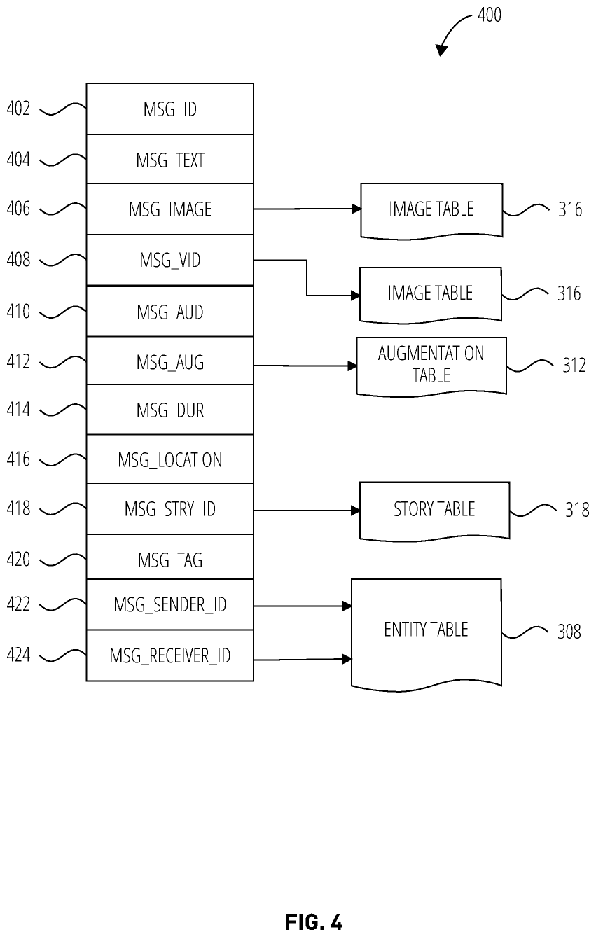

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more shared content collections (e.g., “stories” identified in the story table 318) with which a particular content item in the message image payload 406 of the message 400 is associated. For example, multiple images within the message image payload 406 may each be associated with multiple shared content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 422 and the message receiver identifier 424 may point to user records stored within an entity table 308.

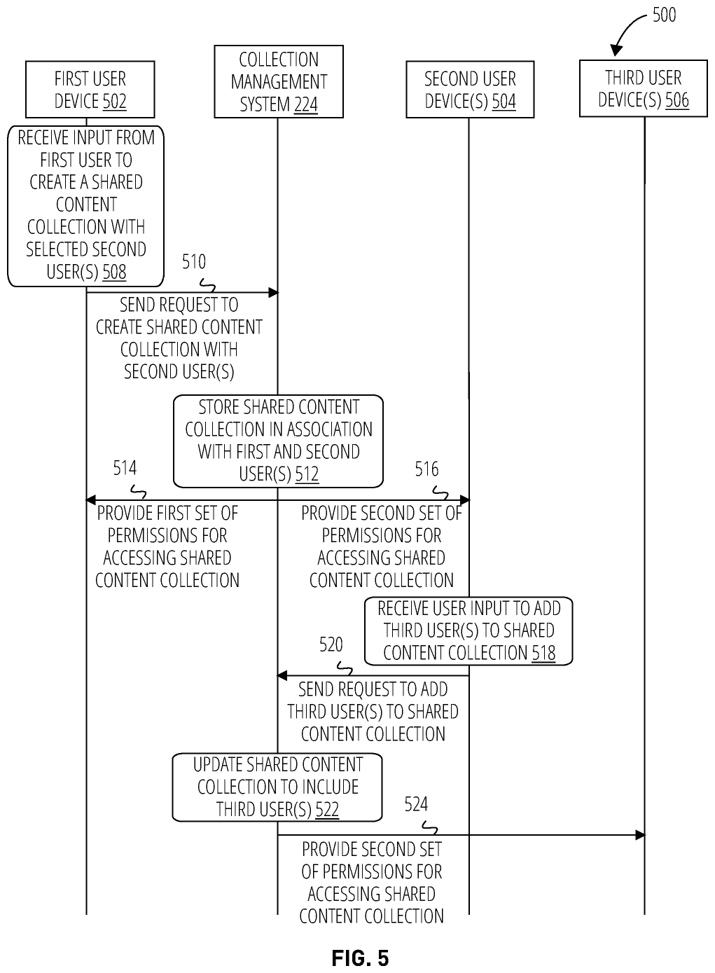

FIG. 5 is an interaction diagram illustrating a process 500 for providing shared content collections within an interaction system, in accordance with some examples. For explanatory purposes, the process 500 is primarily described herein with reference to the interaction client 104 of FIG. 1, as an example of a media application, and the collection management system 224 of FIG. 2. However, one or more blocks (or operations) of the process 500 may be performed by one or more other components, and/or by other suitable devices. Further for explanatory purposes, the blocks (or operations) of the process 500 are described herein as occurring in serial, or linearly. However, multiple blocks (or operations) of the 500 may occur in parallel or concurrently. In addition, the blocks (or operations) of the process 500 need not be performed in the order shown and/or one or more blocks (or operations) of the process 500 need not be performed and/or can be replaced by other operations. The process 500 may be terminated when its operations are completed. In addition, the process 500 may correspond to a method, a procedure, an algorithm, etc.

In some examples, each of a first user device 502, second user device(s) 504 and third user device(s) 506 have instances of the interaction client 104 installed thereon. The first user device 502, second user device(s) 504 and third user device(s) 506 are associated with a respective first user, second user(s) and third user(s) of the interaction system 100. For example, the first user is associated with a first user account of the interaction system 100, each of the second user(s) is associated with respective second user account(s) of the interaction system 100, and each of the third user(s) is associated with respective third user account(s) of the interaction system 100.

As noted above, the first user, second user(s) and third users are identified by the interaction system 100 based on unique identifiers (e.g., an interaction system identifier, email address and/or a device identifier) associated with respective user accounts for the first user, second user(s) and third user(s). In some examples, the messaging system 210 implements and/or works in conjunction with a social network system 222, which is configured to identify other users (e.g., connections or contacts) with which a particular user has relationships.

As noted above, the collection management system 224 may correspond to a subsystem of the interaction system 100, and may be supported on the client side by the interaction client 104 and/or on the server side by the application servers 124. Thus, the operations described herein with respect to the collection management system 224 may be implemented client side, server side and/or a combination of client side and server side.

As described herein, the collection management system 224 is configured to provide for a first user (e.g., the first user of the first user device 502) to create a content collection including one or more content items. The content items may, for example, include image content, video content, text, audio content, augmentations, and combinations thereof.

The collection management system 224 further provides for the first user to share the content collection with one or more second user(s) selected by the first user. The first user may transmit a content collection sharing selection via the first user device 502 to add one or more other users as members of the content collection. In this way, each of the first user and second user(s) are associated with the content collection, and the content collection may be referred to as a shared content collection. By virtue of being associated with the shared content collection, each of the first and second user(s) is able to view the content collection, and to add content (e.g., additional content items) to the content collection. In addition, each of the first user and second user(s) is permitted to share the content collection with one or more selected third user(s).

The collection management system 224 may provide the first user, who initially created and shared the content collection, with different permissions for accessing the content collection relative to the permissions provided to the second user(s) and third user(s). For example, all associated users are permitted to share the content collection with additional users, to add media content to the content collection, and to view the content collection. However, the first user may be further permitted to delete the content collection, rename the content collection and remove users associated with the content collection.

Referring now to the process 500 shown in FIG. 5, at block 508, the interaction client 104 running on the first user device 502 receives input from the first user, to create a shared content collection for one or more second user(s) selected by the first user. For example, the collection management system 224 provides different interfaces from which the first user can create a shared content collection, including a user profile interface and a send interface.

The user profile interface is a user-selectable interface provided by the interaction client 104 running on the first user device 502, and corresponds to the above-described self profile (e.g., “my profile” of the first user). The self profile for the first user is based on profile data as maintained by the augmentation creation system 214 in conjunction with the profile data 302. For example, the self profile may indicate one or more of the user name, telephone number, address, settings (e.g., notification and privacy settings), a list of friends (e.g., contacts) and/or a user-selected avatar representation (or collection of such avatar representations) for the first user.

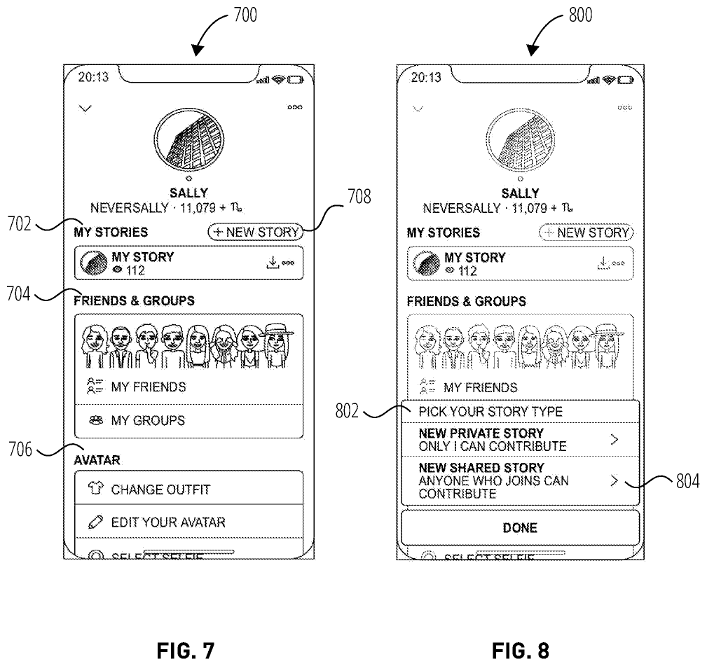

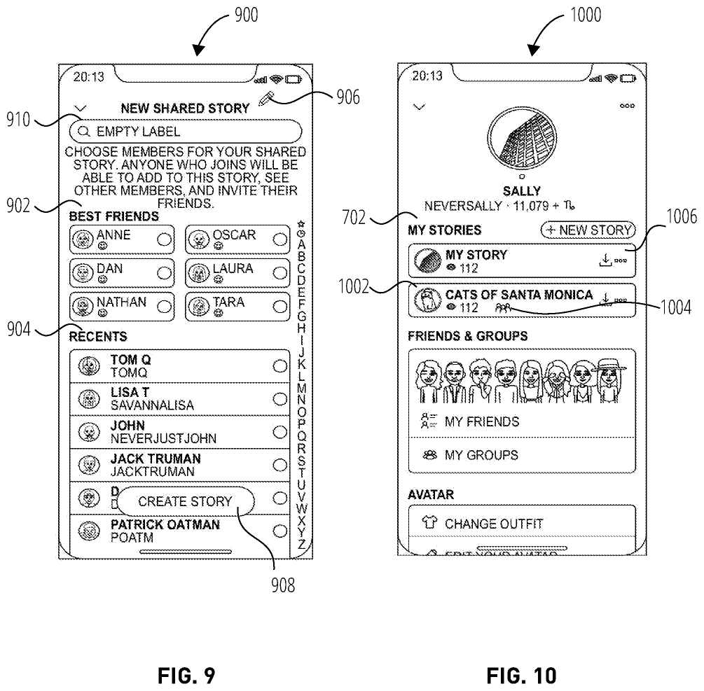

As discussed below with respect to FIG. 7, the self profile further includes a user-selectable element to create a new content collection (e.g., a “new story” button). In response to user selection of this element, the collection management system 224 provides a user-selectable option on the interaction client 104 running on the first user device 502, from which the first user may select to create the new content collection as either private or shared (e.g., as discussed below with respect to FIG. 8). In a case where the first user selects to create the new content collection as a shared collection, the collection management system 224 provides for the first user to select the one or more second user(s) to share the content collection with (e.g., as discussed below with respect to FIG. 9). The one or more second user(s) may be individually selectable from among the contacts (which may be referred to as “friends”) of the first user within the interaction client 104. After the one or more second user(s) are selected, the collection management system 224 provides interface elements for the first user to select/create the content collection.

The first user (and other users in the shared content collection) may make content addition selections to add content items to the shared content collection. In some examples, the interaction client 104 (in conjunction with the collection management system 224) provides the first user with interface element(s) for selecting previously-stored content item(s) to include in the content collection. The content item(s) may be selected from a library. For example, the library may be associated with the user account of the user, and may include media content items (which includes image, video and/or annotations) and/or prior content collections that were previously generated and saved by the user (e.g., in the database 128).

In some examples, the interaction client 104 (in conjunction with the collection management system 224) provides interface elements to generate a content collection using one or more newly-created content items. In response to user selection of such interface elements, the interaction client 104 launches the device camera, which may correspond to a front-facing camera (e.g., for capturing image/video which depicts the user's face), or to a rear-facing camera (e.g., for capturing image/video of another object, scenery of the like). The captured image/video, together with any annotations, overlays, augmented reality content and the like, is used to generate the media content item(s) for adding to the shared content collection.

As noted above, the send interface provides an alternate manner by which the first user can create a shared content collection. For example, upon activation, the interaction client 104 may automatically launch the device camera in association with an interface for generating a content item. This may be in the form of a modular camera function. The interface may include a “send” button, which is selectable to direct to the send interface. The send interface includes various interface elements for sending the generated media content item to friends, saving the content item, and/or broadcasting the content item in association with a feed interface.

The send interface may further include a user-selectable element to create a content collection (e.g., a “new story” button) based on the generated content item. In response to user selection of the “new story” button within the send interface, the collection management system 224 may provide a user-selectable option on the interaction client 104 running on the first user device 502, from which the first user may select to create the new content collection as either private or shared. In a case where the first user selects to create the new content collection as a shared collection, the collection management system 224 provides for the first user to select the one or more second user(s) for sharing the content collection with.

Thus, the first user device 502 sends, to the collection management system 224, a request to create a shared content collection with the selected second user(s) (operation 510). In response, the collection management system 224 stores the shared content collection in association with the first user and the second user(s) (block 512).

For example, the collection management system 224 provides for storing the content collection, which includes a set of content items, within the story table 318. Storing the content collection in association with the first user and the second user(s) provides for the content collection to be accessible by the first and second user(s), and not accessible by other users who are not associated with (e.g., are not members of) the shared content collection.

As noted above, each of the first user and the second user(s) may view their respective self profiles from their respective first user device 502 and second user device(s) 504. The collection management system 224 may cause each respective device to display a user-selectable interface element corresponding to the shared content collection within a self profile. The interface element may include an icon indicating a content collection which is shared, and further indicate a number of times the content collection has been viewed by the members (e.g., first and second users) of the content collection.

In storing the associations between the content collection and the first and second user(s), the collection management system 224 may store an indication that the first user is a creator of the content collection (e.g., a user who initially created and shared the content collection). The collection management system 224 may provide the first user with different permissions for accessing the content collection relative to the permissions provided to the second user(s). Thus, the collection management system 224 provides a first set of permissions for accessing the shared content collection to the first user device 502 (operation 514), and provides a second set of content permissions for accessing the shared content collection to the second user device(s) 504 (operation 516).

For example, the first and second sets of permissions allow all members of the content collection (e.g., the first and second user(s)) to share the content collection with additional users, to add content (e.g., additional content items) to the content collection, and to view the content collection. However, the first set of permissions may further allow the first user to delete the content collection (e.g., causing the collection management system 224 to delete the content collection and its content items from the database 128, and to remove the shared content collection from the self profiles of the members), to rename the content collection, to remove users associated with the content collection, or combinations thereof.

In one or more examples, in lieu of granting one of the second user(s) permission to delete the content collection in its entirety, the second set of permissions allows a second user to leave (e.g., be removed from) the shared content collection. For example, in response to user selection of an appropriate interface element presented on the corresponding second user device(s) 504, the collection management system 224 removes the association between the content collection and the second user (e.g., as stored within the story table 318), and removes any content items added by the second user from the content collection (e.g., as stored within the story table 318).

In one or more examples, the first set of permissions allows the first user to user select to automatically save any content added by the first user with respect to the content collection (e.g., in a library associated with a user account of the first user). In a similar manner, the second set of permissions allows the second user to select to automatically save any content added by the second user with respect to the content collection (e.g., in a library associated with a user account of the second user).

In the example of FIG. 5, one of the second user device(s) 504 receives user input, from a corresponding one of the second user(s), to add one or more third user(s) selected by the second user (block 518). That second client device sends, to the collection management system 224, a request to add the third user(s) to the shared content collection (operation 520). In response, the collection management system 224 updates the shared content collection (e.g., via the story table 318) to include the third user(s) (block 522).

For example, the selected one or more third user(s) correspond to contact(s) of the second user within the interaction system 100. It is possible, but not a requirement of the collection management system 224, for the first user to be an existing contact of the third user(s). As such, it is possible for any of the one or more third user(s) not to be an existing contact of the first user. In cases where the first user is not a contact of one or more of the third user(s), the collection management system 224 is configured to provide an interface element on the appropriate third user device(s) 506, for adding the first user as a contact. Such an interface element may be presented on the third user device(s) 506 in association with viewing the shared content collection, e.g., in conjunction with a content item shared by the first user in a content collection interface.

The collection management system 224 may provide, for the third user device(s) 506, the second set of permissions for accessing the shared content collection (operation 524). As noted above, the second set of content permissions is more restrictive than the first set of content permissions provided to the first user. As such, the access permissions for the third user(s) are similar to those for the second user(s). However, the third user(s) have more restricted access relative to the first user, with respect to the shared content collection.

In some examples, users that have access to the shared content collection may create a combined content item using a content item shared to the shared content collection by any of the users. This may be referred to as creating a “remix” of the (original) content item. However, in some examples, an (original) content item may only be “remixed” if the originating user that posted the (original) content item has authorized “remixing” of the item.

While not shown in the example of FIG. 5, one of the third user(s) may opt to add one or more fourth user(s) to the members of the shared content collection. The added fourth user(s) may also be granted the second set of permissions for accessing the shared content collection. In one or more examples, the collection management system 224 may have a predefined cap of members (e.g., a maximum number such as 15,000 members) for the shared content collection. The predefined number may be set by an administrator of the interaction system 100. In a case where the predefined cap is reached, the collection management system 224 prohibits adding additional members to the shared content collection.

Regarding viewing, the collection management system 224 provides for any of the members to view the shared content collection within a content collection interface of the interaction client 104. The shared content collection may be represented as a selectable tile within a content feed provided by the collection management system 224, such that selection of that tile causes presentation of the content collection interface. In some examples, the shared content collection comprises a set of content items, with the content collection interface providing a sequential presentation of the set of content items. A user may be able to navigate or scroll through the sequence as desired.

In one or more examples, the interaction system 100 provides multiple types of content feeds for viewing. The interaction client 104 in conjunction with the interaction servers 124, provides for an end user, at any of the devices (502, 504, 506) to switch between different interfaces (e.g., switching between a first tab and a second tab via respective swipe gestures) for presenting content feeds and/or content items.

The first tab may correspond with viewing content collections (e.g., stories), with each content collection including one or more media content items. A content feed may correspond to a set of content collections for particular types of entities. In one or more examples, a first content feed of the first tab is associated with contacts (connections) of a user, a second content feed is associated with content provided by publishers to which the end user subscribes, and a third content feed is associated with content provided by publishers to which the end user does not subscribe. As noted above, the profile system 236 may implement various functions for maintaining profiles for contacts and publishers (e.g., which may be subscription-based or non-subscription based with respect to an end user).

Each of the content feeds may be presented within separate sections within the first tab. For example, the first content feed includes content collections that are categorized under a “friends” section (e.g., header). A shared content collection may be included within the first content feed, and categorized within the “friends” section of the first tab. The first content feed may also include private content collections.

On the other hand, the second content feed may include content collections that are categorized under a “subscriptions” section. In addition, the third content feed includes content collections which are categorized under a non-subscription (e.g., “for you”) section.

In this regard, the interaction client 104 presents each content collection (e.g., story) within the first tab as an individual icon (e.g., tile). For example, each of the “friends” section, the “subscriptions” section, and the “for you” section may include a set of respective tiles, each tile being selectable by the end user. Each tile may include one or more thumbnails with representative images corresponding to the content collection (e.g., for a particular friend or publisher), a title of the content collection, and/or the entity (e.g., identity of the friend or publisher) associated with the content collection. User selection of the tile causes the interaction client 104 to display the content collection corresponding to the selected tile.

In one or more examples, the tiles for a particular content feed are displayed in a ranked order. The ranking for the tiles (e.g., content collections) may be based on metadata stored by the collection management system 224 in association with each content collection. Such metadata may indicate if a given content collection has been viewed by the end user, when the content collection was generated (e.g., based on timestamps), the popularity of the content collection, and the like.

The second tab (not shown) may correspond with viewing individual media content items submitted by different entities (e.g., creators, publishers, and the like). In one or more examples, the interaction system 100 may automatically select content items for inclusion in the second interface based on overall user popularity. User popularity for a media content item may be based on one or more of a number of system-wide views, user-submitted comments, user-submitted endorsements, and the like.

Thus, the interaction system 100 that enables different entities to provide content feeds that are selectable for viewing by an end user. Content feeds (e.g., sets of content collections) associated with contacts of a user, publishers to which the end user subscribes, and publishers to which the end user does not subscribe may be accessible within respective sections of the first tab. A separate content feed is included in a second tab, and may include popular content items associated with publishers, creators and the like. Moreover, as noted above, the profile system 236 in conjunction with profile data 302 provides for accessing contact profiles and/or public profiles.

A user wishing to view a shared content collection may select the corresponding tile within the “friends” section of first tab. In response, the collection management system 224 causes display of the shared content collection via the content collection interface. The content collection interface provides the user with action options with respect to the displayed content collection, such as adding members, saving, auto-saving, seeing viewers, and adding to the shared content collection. Further, the content collection interface may provide the user with options, facilitated by the remix system 234, relating to combined content items, e.g., combining a first content item forming part of the shared collection with another content item, and then posting the combined content item back into the shared content collection.

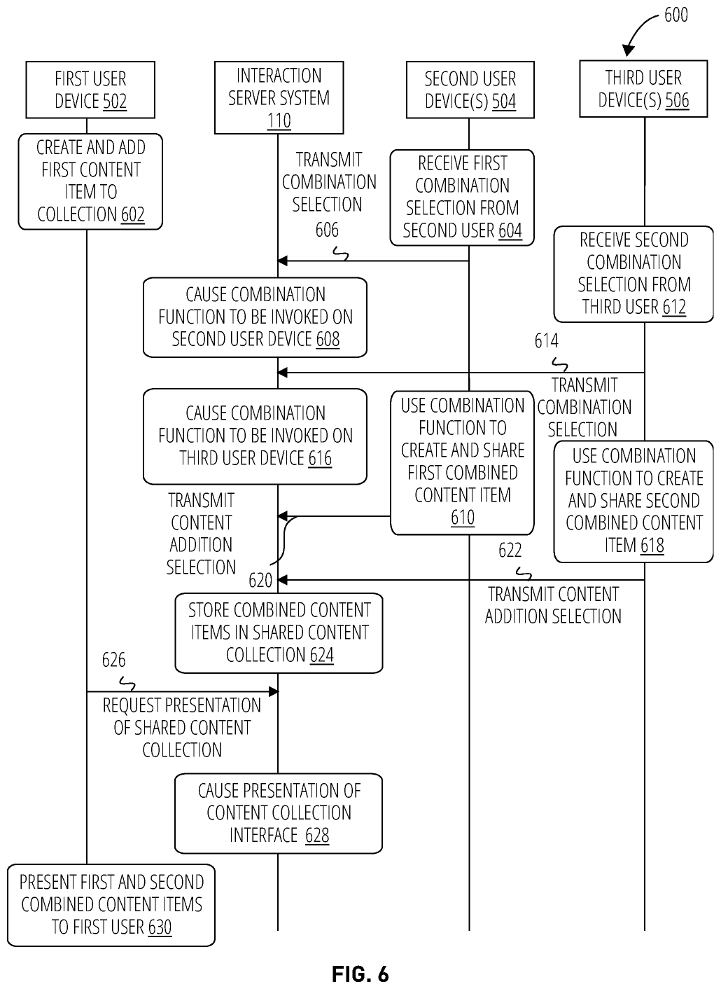

FIG. 6 is an interaction diagram illustrating a process 600 for combining content items in a shared content collection within an interaction system 100, in accordance with some examples. For explanatory purposes, the process 600 is primarily described herein with reference to the interaction client 104 and the interaction server system 110 of FIG. 1, as an example of a media application implemented by a server system, together with the remix system 234 and the collection management system 224 of FIG. 2. As noted above, the collection management system 224 and remix system 234 may each correspond to a subsystem of the interaction system 100, and may be supported on the client side by the interaction client 104 and/or on the server side by the application servers 124. Thus, the operations described herein with respect to such systems may be implemented client side, server side and/or a combination of client side and server side.

Further, the user devices 502, 504, 506 of FIG. 5 are again referred to with reference to FIG. 6. However, one or more blocks (or operations) of the process 600 may be performed by one or more other components, and/or by other suitable devices. Further for explanatory purposes, the blocks (or operations) of the process 600 are described herein as occurring in serial, or linearly. However, multiple blocks (or operations) of the 600 may occur in parallel or concurrently. In addition, the blocks (or operations) of the process 600 need not be performed in the order shown and/or one or more blocks (or operations) of the process 600 need not be performed and/or can be replaced by other operations. The process 600 may be terminated when its operations are completed. In addition, the process 600 may correspond to a method, a procedure, an algorithm, etc.

As mentioned above, the first user device 502, second user device(s) 504 and third user device(s) 506 are associated with a respective first user, second user(s) and third user(s) of the interaction system 100. A shared content collection may be shared between the first user, second user(s) and third user(s).

Subsequent to the creation of the shared content collection and the sharing of the shared content collection between the first user, second user(s) and third user(s), a specific second user may wish to create a combined content item (the second user is used merely as an example and it should be appreciated that first or third user(s) may also perform actions as described below).

For example, the second user may view a first content item created and added to the shared content collection by the first user (block 602 in FIG. 6), e.g., an image or video clip created by the first user using the first user device 502, or selected by the first user from a storage component. Instead of, for example, simply adding a new content item to the shared content collection as a “reaction” to the first content item, the second user may wish to interact more directly and/or creatively with the first content item by using the first content item to create a combined content item.

The second user then makes a first combination selection via the second user device 504. At block 604, the second user device 504 receives the first combination selection. The first combination selection may, for example, be selection of a remix button on a user interface of the media application, displayed in conjunction or in association with the first content item. Alternatively, the first combination selection may be a predefined user input action, such as a press-and-hold action directed at the first content item.

The second user device 504 transmits an indication of the first combination selection to the interaction server system 110 (operation 606). In response, the interaction server system 110 causes a combination function of the interaction client 104, also referred to as a remix function, to be invoked on the second user device 504 (block 608), using the remix system 234.

As mentioned, the combination function may, in some examples, only be available or invoked after determining third-party authorization for the viewed content item to be combined with other content items to create combined content items (e.g., authorization from the first user to combine the first content item). In some examples, responsive to determining the third-party authorization, the interaction system 100 may automatically cause presentation on the viewing user device (e.g., second user device 504) of a combination graphical element which is user-selectable to invoke the combination function.

Once the combination function has been invoked on the second user device 504, the second user device 504 enables the second user to create a first combined content item and share the first combined content item (block 610).

A combined content item may be created in a number of ways, according to examples of the present disclosure. Users are enabled (via the remix system 234, for example) to combine multiple content items (including user-generated and user-selected content items) into combined content items within the context of a shared content collection, thereby providing enhanced software and system functionality and providing users with a powerful storytelling mechanism. For example, where an active user (e.g., the first user) is viewing a content item in the example form of a third-party image within the content collection interface of the interaction client 104 (another example may be a third-party video clip, or an image/video with added audio content), activation of the combination function provides the ability to access a combination augmentation or lens (e.g., a “remix lens”), in order to create a combined content item that includes the third-party image. A remix button may be user-selectable to trigger the combination function, or the active user may perform another predefined user input action to trigger the combination function.

Returning to the discussion of FIG. 6, various sharing options may be provided once the first combined content item has been created by the second user, e.g., sharing the first combined content item to the shared content collection, sharing the first combined content item to the creator of the first content item (e.g., first user) via a direct message, sharing the first combined content item to the second user's “story”, or the like. In some examples, and as shown in FIG. 6, the second user opts to share the first combined content item “back to” the shared content collection to make it available to the other members of the shared content collection.

After the creation of the shared content collection and the sharing of the shared content collection between the first user, second user(s) and third user(s), a specific one of the third user(s) may also wish to create a combined content item. For example, the third user may also view the first content item created and added to the shared content collection by the first user and wish to create a “remix” of the first content item. The third user makes a second combination selection via the third user device 506 (the user action or input associated with the second combination selection may the same as the user action or input required to perform the first combination selection). At block 612, the third user device 506 receives the second combination selection.

The third user device 506 transmits an indication of the second combination selection to the interaction server system 110 (operation 614). In response, the interaction server system 110 causes the combination function to be invoked on the third user device 506 (block 616). Once the combination function has been invoked on the third user device 506, the third user device 506 enables the third user to create a second combined content item, which is selected for sharing to the shared content collection (block 618).

The interaction server system 110, e.g., via the collection management system 224, may receive content addition selections (operation 620 and operation 622) from the second user device 504 and the third user device 506, respectively indicating that the first combined content item and the second combined content item are to be added to the shared content collection. In response thereto, these combined content items are stored in association with the shared content collection (block 624), making them available for presentation when a member of the shared content collection requests to view or navigate the shared content collection. The combined content items may, for example, be added at the end of a current sequence of content items constituting the shared content collection.

The first user, responsible for creating and adding the first content item, then, via the first user device 502, requests presentation of the shared content collection (operation 626). In response, the content collection interface of the interaction client 104 is caused to be presented on the first user device 502 at block 628. The first user is then able to view and interact with (e.g., like, respond to, or further “remix”), the first combined content item and the second combined content item respectively at block 630. The first user (and each other member opting to view the items) is thus conveniently and automatically presented with shared responses of other users to the first content item. The first user (and other users who are members of the shared content collection) may view and interact with content items shared by both users they are connected with and users they are not connected with within the media application (e.g., “friends”, and those lacking a “friend” relationship). The interaction system 100 may be configured to automatically present and apply different interaction options based on this connection relationship between specific pairs of users in the shared content collection, as described further below.

Thus, the interaction system 100 as described herein may provide for a first user to create a content collection for sharing with one or more second user(s), who can in turn share the content collection with additional third user(s). In addition, the collection management system 224 may provide the first user, who created the content collection, with more permissions for accessing the content collection relative to the permissions provided to the second user(s) and third user(s). Furthermore, the interaction system 100 may allow members of the shared content collection to create combined content items and share those combined content items with the members of the shared content collection. For example, a first user, not being a contact of a third user (e.g., the third user may have been added to the shared content collection by a second user, who is a contact of the first user and third user), may view a content item shared by the third user, create a combined content item based on the content item of the third user, and share the combined content item for viewing by all members of the shared content collection.

By virtue of providing and enabling content combinations in shared content collections in this manner, it is possible to increase the visibility of particular content collections and/or to increase user engagement with respect to content feeds. Without providing for content collections that can be shared, combined and/or modified in this manner, end users may be limited to a certain extent in viewing or interacting with content and/or may perform workarounds (e.g., locally saving a content collection, and redistributing it) which are inefficient and may not as easily indicate attribution to the original creator of the content collection. As such, the interaction system 100 saves time for the user, unlocks new sharing options, reduces computational resources/processing power associated with having to perform workarounds, and/or improves attributing media content to creators. Moreover, the sharing of content collections as described herein may be more engaging for users of the interaction system 100. For example, a user is provided with enhanced functionality for interacting with other users who are not necessarily contacts (e.g., “friends”) of the other users, or with content shared by the other users, via a shared content collection of which the user and the other users are members.

FIG. 7 illustrates a user interface 700 corresponding to a user profile, including an interface element for creating a content collection, in accordance with some examples. The user interface 700, as well as other exemplary user interfaces shown and described herein, may be executed on any suitable device, such as a user system 102.

The user interface 700 includes a content collections section 702, a friends and groups section 704, an avatar section 706 and an interface element for creating a content collection in the example form of a new content collection button 708.

The user interface 700 corresponds to a self profile (e.g., of a first user) creating a shared content collection. As noted above, the self profile for the first user is based on profile data as maintained by the profile system 236 in conjunction with the profile data 302. The self profile indicates the user name and other identifying information of the user. The content collections section 702 lists private and shared content collections associated with the first user. The friends and groups section 704 indicates friends (e.g., other users in the interaction system 100 corresponding to contacts of the first user within the interaction client 104) and groups of the first user (e.g., represented by collapsible friend entries and group entries, each of which is user-selectable to redirect to a respective friend profile or group profile), and the avatar section 706 provides interface elements for viewing and/or editing avatar(s) associated with the self profile of the first user.

The user interface 700 further includes the new content collection button 708, which is selectable by the first user to create a new content collection. The new content collection may be created as private or shared, as discussed below with respect to FIG. 8.

FIG. 8 illustrates a user interface 800 for selecting between creating a private content collection or a shared content collection, in accordance with some examples. The user interface 800 includes a new content collection options 802 element, which is presented as an overlay with respect to the user interface 800 of FIG. 7.

As shown in FIG. 8, the new content collection options 802 include user-selectable options to create a content collection as either private or shared. The first user selects to create a shared content collection by selecting a new shared content collection element 804 in the example form of a “new shared story” option, as depicted in FIG. 8, thereby redirecting the interaction client 104 to the user interface 900 shown in FIG. 9.

FIG. 9 illustrates a user interface 900 for selecting users to associate with a shared content collection, in accordance with some examples. The user interface 900 allows for the first user to select friends with which to share the content collection. In some examples, these “friends” are selected from the second user(s) described above, being a list of contacts of the first user within the interaction client 104. In other words, and as mentioned above, “friends” of the first user may be those other users of the interaction system 100 with which the first user holds a bidirectional relationship, also referred to herein as “contacts.”

The first user thus makes one or more user addition selection to add one or more users as members of the shared content collection. In some examples, and as is the case in FIG. 9, the first user can only add contacts to the shared content collection, and cannot add users of the interaction system 100 with which the first user does not hold a bidirectional relationship. However, a second user added by the first user may then add further members from the contacts of the second user. At least one of those further members may, in some examples, not be a contact of the first user. In this way, a third user and a first user, while not having a bidirectional relationship, can be connected in order to interact via a shared content collection.

For example, the first user may select the second user(s) via a best friends section 902, which is populated based at least in part on message frequency between users and/or user-specified designation of “best” (e.g., closest) friends. Selectable friends may also be presented based on recent contact (e.g., recent messaging, calls or other communication) between the users within the recent friends section 904. In addition, the user interface 900 allows for searching (via a search bar 910) and scrolling through all friends (e.g., contacts) of the first user in order to select the second user(s).

The user interface 900 further includes a content collection name section 906, for setting a name for the shared content collection. The name may be set by the first user via selection of an edit icon (e.g., a pencil icon as shown in FIG. 9). In one or more examples, the collection management system 224 is configured to prohibit use of certain names via a blacklist (e.g., stored in the database 128). For example, the blacklist includes predefined names and/or terms that are not permitted with respect to setting a name. The first user may confirm creation of the shared story, for example, by selecting the create story button 908. Selection of the create story button 908 may prompt the first user to confirm the name of the shared content collection (e.g., where the name may default to a predefined name of “<first user name>'s shared story”).

In some examples, the create story button 908 may serve both as a content collection creating selection and a content collection sharing selection (e.g., an instruction to create the shared content collection and to share it with one or more specific users).

FIG. 10 illustrates an example user interface 1000 corresponding to a user profile of a creating user of a shared content collection, in accordance with some examples. The user interface 1000 corresponds to the self profile of a first user as depicted in FIG. 7, but updated to indicate the created shared content collection. In FIG. 10, the shared content collection is called “Cats of Santa Monica” and was created by the first user, e.g., via the first user device 502.

The created shared content collection is represented within the content collections section 702, as a separate shared content collection entry 1002. The shared content collection entry 1002 indicates the name of the content collection (e.g., “Cats of Santa Monica”) as set by the first user. In FIG. 10, the shared content collection entry 1002 indicates that the content collection is shared (e.g., per corresponding shared icon 1004 within the entry, in contrast with the “My Story” content collection 1006 which is not shared and thus does not include a shared icon). The shared content collection entry 1002 further indicates a number of views (e.g., by members of the shared content collection). The shared content collection entry 1002 is user-selectable by the first user to view the corresponding shared content collection.

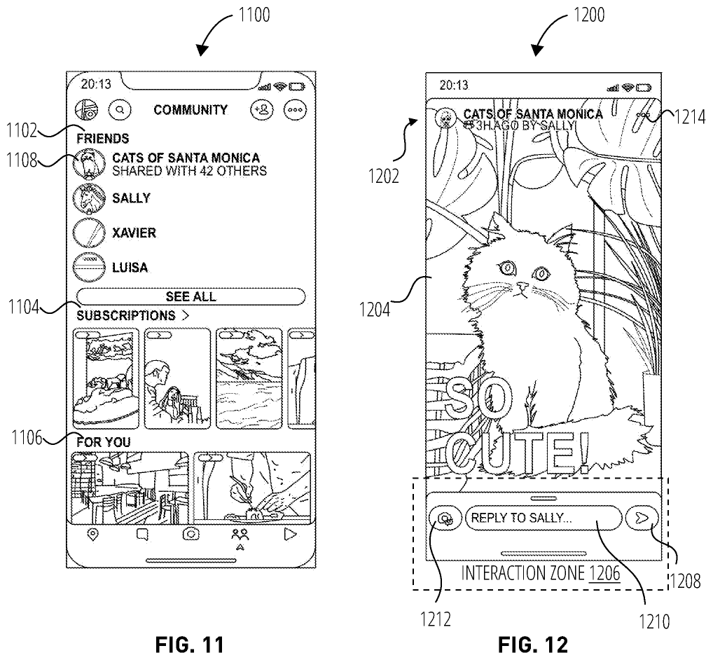

FIG. 11 illustrates a user interface 1100 for selecting to view a shared content collection, in accordance with some examples. As noted above, the interaction system 100 may provide for first, second and third content feeds to be presented within separate sections of a first tab of the interaction client 104. The user interface 1100 provides for the first content feed (e.g., associated with friends of a user) within a friends section 1102, the second content feed (e.g., associated with content provided by publishers to which the end user subscribes) within a subscription section 1104, and the third content feed (e.g., associated with content provided by publishers to which the end user does not subscribe) within a non-subscription section 1106.

In FIG. 11, the friends section 1102 includes a shared content collection entry 1108, which is user-selectable (e.g., by members of the corresponding shared content collection) for viewing. The shared content collection entry 1108 indicates the number of members for the shared content collection (e.g., “shared with 42 others”). Selection of the shared content collection entry 1108 will redirect the interaction client 104 to a user interface for viewing and interacting with content items in the shared content collection and/or members of the shared content collection, referred to herein as a content collection interface.

FIG. 12 illustrates the content collection interface 1200, for viewing a shared content collection and interacting with content items and members of the shared content collection, in accordance with some examples.

The content collection interface 1200 includes a header 1202 which indicates the name of the shared content collection (e.g., “Cats of Santa Monica”), the creator of the shared content collection, a time of creation, and an icon indicating that the content collection is shared. Other information may be included, such as the number of times the content collection has been shared, the number of times the current content item has been viewed/shared, or the like.

The content collection interface 1200 also displays a current content item in the example form of a first content item 1204, being displayed with respect to the shared content collection. As noted above, the content collection may include multiple content items, which may be cycled through in chronological order based on a predefined schedule and/or sequence and/or based on user input (e.g., clicks, swipes) to advance or reverse through the content items. In FIG. 12, the first content item 1204 is an image of a cat with the text “SO CUTE!” overlaid onto the image. The first content item 1204 was created and shared to the shared content collection by the first user, and is viewable by all members of the shared content collection.

The content collection interface 1200 further includes an interaction zone 1206 providing a set of selectable interaction elements, based on a connection relationship between the viewing user and the creator of the first content item 1204. In some examples, and as is the case in FIG. 12, the first content item 1204 is being viewed by a second user who is a member of the shared content collection and is a contact (“friend”) of the first user (creator). Based on this connection relationship, the collection management system 224 provides a set of three interaction elements: a send to button 1208, a reply graphical element in the form of a reply to creator button 1210, and a remix button 1212. User selection of the send to button 1208 enables the user to send the first content item 1204 to one or more destinations (e.g., share via a direct message or post to the user's own personal story). User selection of the reply to creator button 1210 enables the second user to reply directly to the first user (the second user is permitted to reply directly to the first user given their bidirectional contact relationship).

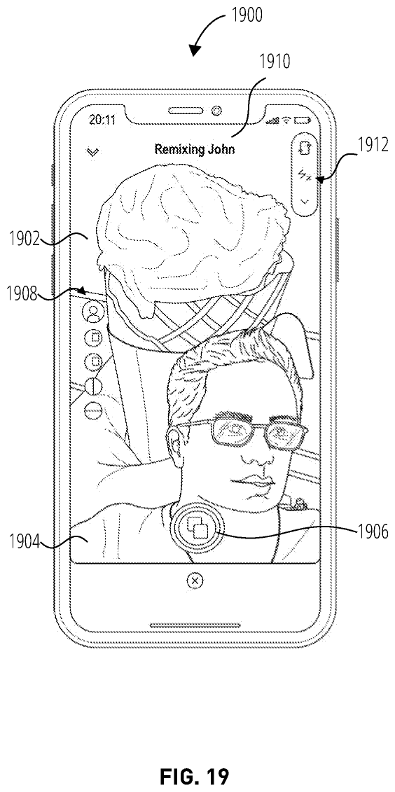

User selection of the remix button 1212 activates a combination function of the media application and causes presentation of a remix camera interface, e.g., controlled or managed using the remix system 234, which is described according to some examples with reference to FIG. 14, FIG. 18 and FIG. 19 below. The combination function enables the second user to combine the first content item 1204 with another content item, generated or selected by the second user, to create a combined content item. The remix camera interface is also referred to as a combination interface and may, in some examples, provide a modular camera function together with one or more additional features, as described with reference to FIG. 14, FIG. 18 and FIG. 19 below.

According to some examples, the collection management system 224 may determine third-party authorization for the first content item 1204 to be combined with other content items to create combined content items. For example, an authorization setting related to the first content item 1204, indicating this authorization, may be detected. The determining third-party authorization for the first content item 1204 to be combined may thus comprise determining a user setting related to the first content item 1204 indicating the third-party authorization. A content creator, when creating or publishing a content item to a shared content collection, may be presented with the option of either allowing or disallowing the use of the item in combination with other content items, created or originated with other users of the interaction system 100. This allowance/disallowance is then recorded and stored in the database 128 as the authorization setting related to the relevant content item, and is accessed to perform the detection of the third-party authorization.

In some examples, in response to detecting the third-party authorization, the collection management system 224 may cause a combination graphical element, e.g., the remix button 1212, to be presented in the content collection interface 1200 automatically, while no combination graphical element is displayed in the absence of third-party authorization. In other examples, the interaction system 100 may be configured so as not to require the third-party authorization (e.g., all content items are “re-mixable” across the interaction system 100), in which case the combination graphical element may simply be presented to a viewing user without conducting the check for third-party authorization.

Turning again to FIG. 12, the remix button 1212 comprises a camera indicium and a graphical component in the example form of an arrow that identifies the combination function of the media application. In other words, the camera indicium and the arrow graphical component are displayed in conjunction with the first content item 1204 within the content collection interface 1200 on the second user device 504 of the second user, to alert the second user that the second user has the option to create a “remix” based on the first content item 1204. The combination of a camera icon with an arrow may make it easier for a user to note that selection of the remix button 1212 will invoke both a camera function (to allow for capturing of a supplemental item) and a “remix” function.

In FIG. 12, the remix button 1212 specifically includes a graphical component (e.g., the arrow shown in conjunction with the camera image) that identifies the combination function. The graphical component may provide a contextual signal to the user, indicative of the option to trigger the combination function and its reply message capabilities. However, the combination function may be triggered by other user input actions and/or other buttons. Further, the arrow shown in FIG. 12 is merely an example. It should thus be appreciated that examples of the present disclosure may include various identifiers of the combination function, e.g., various different augmentations or supplements to a camera button, or a different button that does not include a camera image, to alert the viewing user of the option to activate the combination function. In this regard, reference may be made, for example, to the remix button 1606, described with reference to FIG. 16, which does not include a camera image or an arrow.

Accordingly, the interaction system 100 may cause presentation, on the second user device 504, of the remix button 1212, and the remix button 1212 is user-selectable to make a combination selection, which invokes the combination function. Once the second user has made the combination selection associated with the first content item 1204, the second user is enabled to access a second content item and to combine the first and second content items, as described further below.

In some examples, in addition to providing the remix button 1212 as a user-selectable option in the interaction zone 1206 (or as an alternative thereto), the user may select the combination feature by navigating to an action menu through user selection of an action menu button 1214 in the header 1202 of the content collection interface 1200. The action menu button 1214 can also be referred to as a “more options” button, depicted as an ellipses icon, to present additional options.

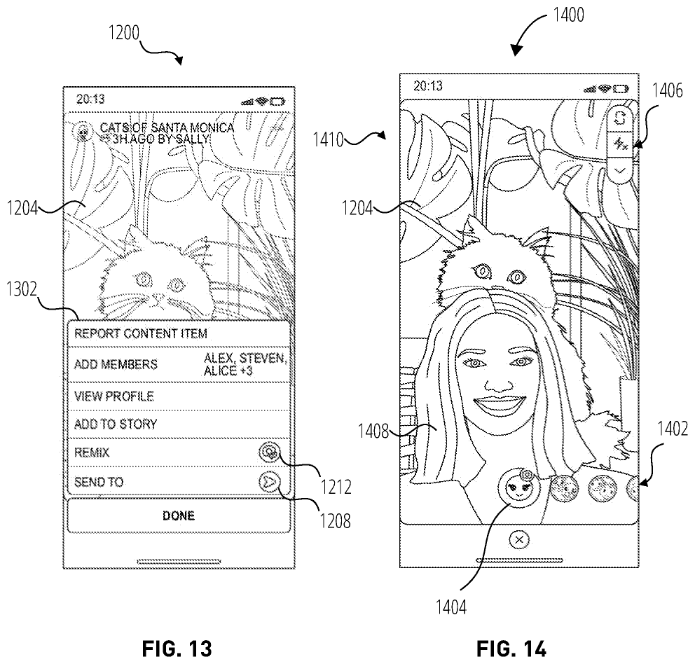

FIG. 13 illustrates the content collection interface 1200, with an action menu presented as an overlay on the first content item 1204, in accordance with some examples.

User selection of the action menu button 1214 shown in FIG. 12 causes the collection management system 224 to present additional options, such as those included in the action menu 1302 in FIG. 13. Alternatively, the user may be enabled to open the action menu 1302 through a different user action, e.g., performing a press and hold action on the first content item 1204.

In FIG. 13, these additional options include reporting the content item, adding members to the shared content collection, viewing the user profile of the creator, and adding the content item being viewed to the viewing user's story. The remix button 1212 and the send to button 1208, included in the interaction zone 1206 and shown in FIG. 12, are also included in the action menu 1302.

In other examples, an action menu may provide further, or other, options to the viewing user. For example, such options may allow the viewing user (e.g., member) to perform one or more of the following actions (depending on permissions): leave the shared content collection, save the shared content collection, auto-save the shared content collection, see viewers of the shared content collection, and add content items to the shared content collection.

FIG. 14 illustrates a remix camera interface 1400, according to some examples. As mentioned, the collection management system 224 may receive an indication of a combination selection made by a user viewing a content item, e.g., user selection, by the second user, of the remix button 1212, and the interaction system 100 (e.g., through the remix system 234) may cause the remix camera interface 1400 to be launched in response thereto.

The remix camera interface 1400 enables the second user, having viewed the first content item 1204 of the first user, to access a second content item and combine the first content item 1204 with the second content item to create the first combined content item. In some examples, the combination function comprises a camera function that enables the second user to select the second content item. Specifically, as shown in FIG. 14, a modular camera function is activated and launched on the second user device in some examples. The modular camera function automatically causes presentation of a digital image feed from a camera of the second user device, e.g., “selfie” camera, to facilitate capturing of the second content item.

The second user uses the remix camera interface 1400 to capture a second content item 1408 in the form of a “selfie” (self-portrait photograph taken using a front camera, for example), which is automatically overlaid onto the first content item 1204 in the manner shown in FIG. 14, to form a combined content item 1410. The modular camera function presents an augmentation carousel 1402 providing a plurality of user-selectable lens elements. The augmentation carousel 1402 is automatically applied to merge or combine the first content item 1204 with the second content item 1408 and apply one or more augmentations, such as lenses or filters, to the second content item 1408 or the combined content item 1410, if desired by the second user.

One of the lens elements is preselected in FIG. 14 (e.g., as indicated by a visual highlighting and/or size differentiation and/or its central position in the remix camera interface 1400). The second user may scroll through the lens elements to move a different lens element into the central, selected position (see the button 1404). Each lens element may be used to apply a different augmentation, filter, modification, or the like, and the remix camera interface 1400 also provides a plurality of camera controls 1406. The capture button 1404 is selected to capture the item, applying the lens element, which is in the central position at that point in time. Alternatively, the second user may be enabled to capture the second content item 1408 and overlay it onto the first content item without applying any additional augmentations, filters, modifications, or the like (see, for example, FIG. 19).

In addition to capturing an image using the device camera, the second user may add additional content, such as the text shown in FIG. 16 to create the second content item or the final combined content item. It will be appreciated that capturing an image using the device camera for the purpose of creating the second content item is merely an example, and that the second content item may, for instance, be selected or generated using another component, e.g., selected from a storage component.

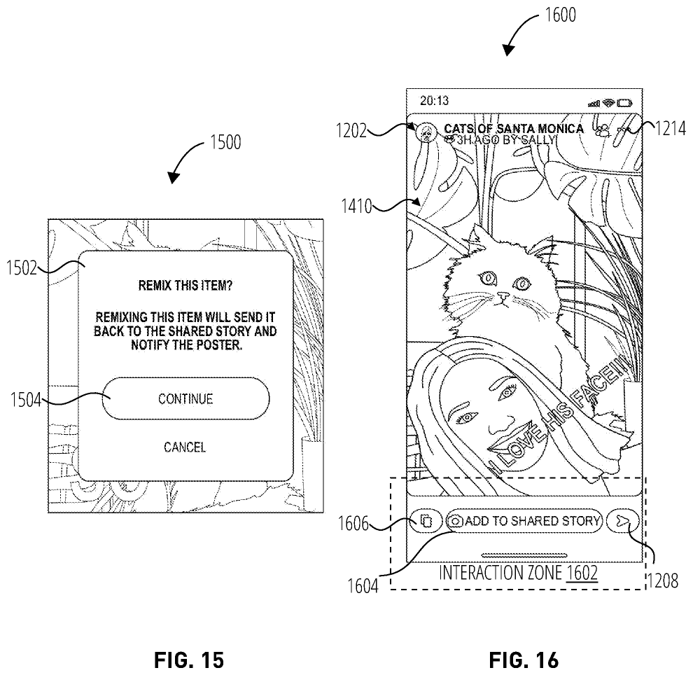

FIG. 15 illustrates part of a user interface 1500 presenting, to the second user via the second user device 504, a confirmation graphical element 1502. The confirmation graphical element 1502 may be presented in response to the second user capturing the second content item 1408, in response to the second user selecting to share the combined content item 1410 to the shared content collection, or prior to capturing the second content item 1408 (e.g., in response to selection of the remix button 1212). The confirmation graphical element 1502 may be overlaid onto the content item the second user is in the process of creating/viewing.

The confirmation graphical element 1502 serves as a user prompt, alerting the viewing user to the consequence of creating the “remix.” Specifically, the confirmation graphical element 1502 provides a message indicating that the combined content item 1410 will, if finalized, be shared into the shared content collection and the creator of the first content item 1204 (first user) will be notified, and the second user is requested to either confirm or cancel these actions. In this case, the second user selects the continue button 1504.

In some examples, once the continue button 1504 has been selected, the collection management system 224 may receive a content addition selection from the second user device, indicating that the combined content item 1410 is to be added to the shared content collection. Responsive to receiving the indication of the content addition selection, the collection management system 224 stores the combined content item 1410 in association with the shared content collection and the combined content item 1410 becomes viewable as part of the shared content collection, e.g., it may be added as a new item at the end of a current content item sequence.

FIG. 16 illustrates the content collection interface 1600, for viewing the shared content collection, which has been updated to include the combined content item 1410, according to some examples.

The content collection interface 1600 includes the header 1202 as described above and displays a current content item being viewed by a viewing user, being the combined content item 1410. For example, after sharing of the combined content item 1410 by the second user, the first user, other second user(s) and any of the third user(s) as described above may view and interact with the combined content item 1410 via the content collection interface 1600. The first user, as the creator of the “original” item, being the first content item 1204, may also receive a notification via the first user device 502, informing the first user that the first content item 1204 has been “re-mixed” or “combined” and is available for viewing in the content collection interface 1600.

Turning specifically to FIG. 16, the content collection interface 1600 includes an interaction zone 1602 providing a set of selectable interaction elements. In some examples, and as is the case in FIG. 16, the interaction zone 1602 includes the send to button 1208 as described above, and also includes an add to shared story button 1604 and a user-selectable remix icon in the form of remix button 1606.

The add to shared story button 1604 is user-selectable to allow a member of the shared content collection to add a further content item to the shared content collection. In some examples, user selection of the add to shared story button 1604 invokes a camera function and automatically transitions the media application to a camera interface to allow the active user to capture a new content item to add to the shared content collection. User selection of the remix button 1606 may activate the combination function of the media application and cause presentation of the remix camera interface, e.g., controlled or managed using the remix system 234, which is described according to some examples with reference to FIG. 14, FIG. 18 and FIG. 19.

In some examples, the combination function enables the active user to combine the combined content item 1410 with a further content item, generated or selected by the second user, to create a further combined content item. Accordingly, user selection of the remix button 1606 may take the user to the remix camera interface where the user can capture/access a new content item to combine with the combined content item 1410.

In other examples, the combination function enables the active user to combine the first content item 1204 with a further content item (as opposed to combining the combined content item 1410 with a further content item). Accordingly, user selection of the remix button 1606 may take the user to the remix camera interface where the user can capture/access a new content item to combine with the “original” item, being the first content item 1204 as discussed above.

Therefore, in some examples, the content collection interface 1600 provides the user with different options for adding content to the shared content collection: the add to shared story button 1604 which can be selected to transition to a standard camera interface for capturing a new content item to add to the shared content collection as a standalone content item, and the remix button 1606 which can be selected to transition to a remix camera interface for capturing a new content item and combining the new content item with an existing content item of the shared content collection in order to add content in the form of a combined item to the shared content collection. In some examples, a content item that has already been combined may be further “remixed” by adding one or more further content items, thereby creating a further combined content item for sharing into the shared content collection.

The viewing user may also select the action menu button 1214 to access further options, as described above.

In some examples, a combined content item such as the combined content item 1410 may be included in the shared content collection only for as long as the original content item, e.g., the first content item 1204, remains available. Where the first content item 1204 and combined content item 1410 are published as ephemeral messages, for example, the combined content item 1410 may expire at the same time as the first content item 1204 even though it was created and shared after the creation and sharing of the first content item 1204. In this way, members of the shared content collection may, for example, post visual reactions to an original content item, in the same shared content collection, for as long as the original content item is available (thus having a limited “lifespan”).

The combined content item 1410 may be presented together with the name or another identifier of the second user (creator of the combined content item 1410) and/or together with suitable attribution data, e.g., the name or another identifier of the first user (creator of the first content item 1204).

As noted above with reference to FIG. 12, the content collection interface may include an interaction zone providing a set of selectable interaction elements based on a connection relationship between the viewing user and the creator of the item being view. In the interface shown in FIG. 12, the viewing user is a contact of the creator, and thus a reply graphical element is included in the interaction zone.

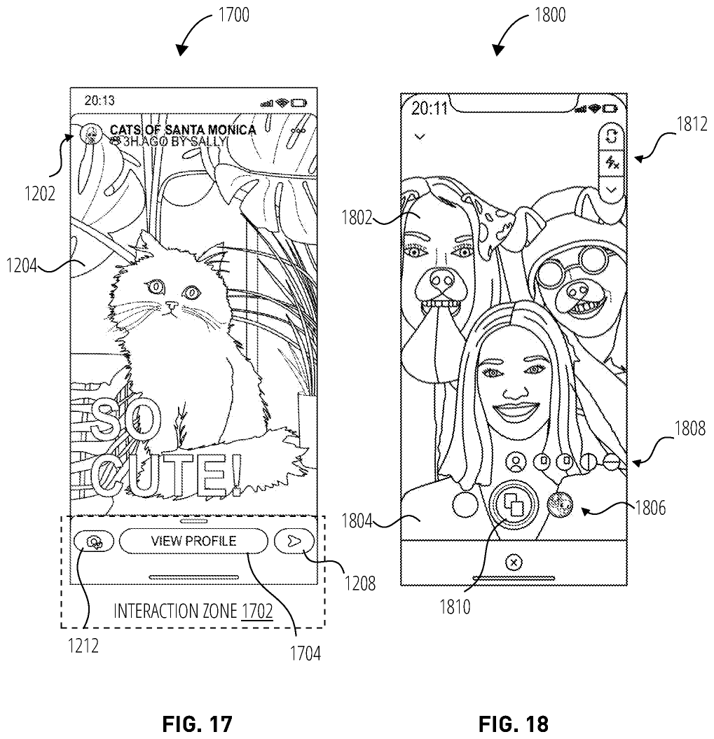

FIG. 17 illustrates the content collection interface 1700, for viewing a shared content collection and interacting with content items and members of the shared content collection, in accordance with some examples. In FIG. 17, one of the third user(s) is viewing the first content item 1204 created by the first user. The content collection interface 1700 includes the header 1202 as described above and further includes an interaction zone 1702.

As shown in FIG. 17, in a case where the creator (e.g., the first user) of the content collection is not a contact of the viewing user (e.g., the third user), the collection management system 224 may identify and cause the interaction zone 1702 to include a different set of selectable interaction elements (when compared to FIG. 12). In this case, the elements include the send to button 1208 and the remix button 1212 described above, but they do not include a reply graphical element, given that the first user and the third user do not have a bidirectional relationship in the interaction system 100. Instead, the interaction zone 1702 includes a view profile button 1704. The view profile button 1704 is selectable by the third user to cause display of a user profile of the first user, e.g., from where the third user may request to add the first user as a contact. In some examples (not shown in FIG. 17), the interaction zone 1702 may also include an interface element (e.g., an add contact button) for the third user to add the first user as a contact directly (or to request to add the first user as a contact).

A remix camera interface according to some examples was described above with reference to FIG. 14. FIG. 18 and FIG. 19 show remix camera interfaces according to further examples.

Turning to the user interface diagram shown in FIG. 18, user selection of a remix button may activate a modular reply camera, causing display of the remix camera interface 1800. The remix camera interface 1800 includes, within an interaction zone, an augmentation carousel in the example form of a lens carousel 1806 that is automatically presented and is populated with a scrollable set of lens icons or buttons including a remix capture button 1810. The remix capture button 1810 is automatically preselected and a corresponding remix function (also referred to as a combination function) applied to a first content item 1802 shared by another member of a shared content collection and a user-selected or user-generated second content item 1804, to display a combined content item in the remix camera interface 1800. The viewing user may then scroll the lens carousel 1806 and select a lens button to apply an augmentation, filter, or the like, to the combined content item. A number of camera controls 1812 are also presented.

A set of layout graphical elements 1808 is also displayed in FIG. 18. Each of the layout options associated with a respective layout graphic element 1808 may allocate a certain section of an interface canvas to each of the images or may define a layout of the images relative to each other. The same layout options may be applied to, or available in respect of, still images and video content. (In some examples, a combined content item may include a still image combined with video content, or vice versa, and various layout options may likewise be available.) In FIG. 18 (also in FIG. 14 and FIG. 19), the combined content item utilizes a layout option in terms of which the active user's image is overlaid onto the third-party image (the latter essentially becoming a background image). Another example may be a “divided screen remix,” in which the active user's image is shown in a first section or block, and the third-party image as shown in a second section or block, separate from the first section or block within the interface. A further example may be a pair of video clips (first content item in the form of a video clip and second content item in the form of a video clip), configured to play sequentially, optionally with audio content, to define the combined content item. The term “layout” may thus refer to relative spatial arrangement and relative temporal arrangement of content items.

Accordingly, accessing a second content item and enabling a user to combine a first content item with the second content item to create a combined content item may comprise invoking a combination function of the interaction client 104 on the relevant user device (e.g., through the use of the remix system 234), with the combination function comprising a layout function to enable the user to specify a layout relationship of the first content item relative to the second content item during presentation of the combined content item.

Referring to the user interface diagram in FIG. 19, a remix camera interface 1900 is shown (also referred to as a combination interface). The remix camera interface 1900 is automatically activated by the remix system 234 in response to a user, when viewing a content item, selecting a remix button (or otherwise invoking the combination function).

A remix lens, or remix augmentation, is automatically applied to merge or combine a first content item 1902 with a second content item 1904, which in FIG. 19 is an image captured as a “selfie” by the user viewing the first content item 1902, to create a combined content item in the remix camera interface 1900.

The remix camera interface 1900 includes a layout tools 1908 with a set of layout graphic elements, each of which is user-selectable to apply a different layout to the combination of the two items. A number of camera controls 1912 are also presented. Once the user is satisfied with the second content item 1904 and the layout, a remix capture button 1906 can be selected to finalize the combined content item. In FIG. 19, the user takes a “selfie” which is overlaid onto a portion of the (original) first content item 1902. However, this is merely an example of a layout used to position the two content items relative to each other.

It will be noted that the remix camera interface 1900 also includes a contextual message 1910 that provides contextual information regarding the combination function (e.g., in this example, indicating that the active user is creating the combined content item based on an original content item by the user “John”—this may, for instance, be an item that was shared to a shared content collection by “John”). The contextual message 1910 may also be user-selectable to invoke the messaging system 210 of the interaction system 100 and conveniently enable the active user to transmit the combined content item directly to the third-party user (e.g., “John”). For example, if the user does not wish to share the combined content item with all members of the shared content collection, and provided the relationship connection between the two users permits direct replies, the user may select the contextual message 1910 to “reply” to the third party's publication of the first content item 1902.

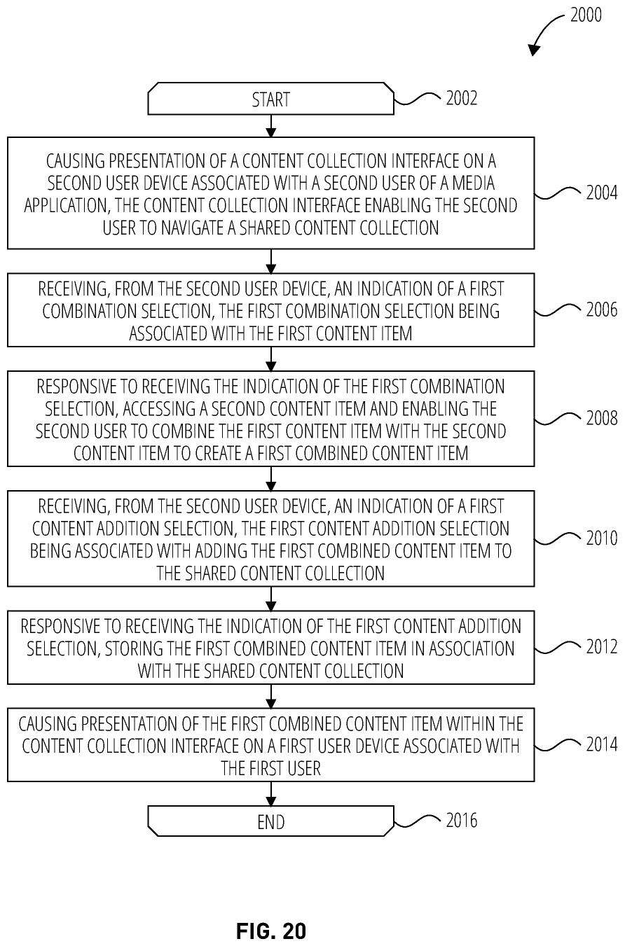

FIG. 20 is a flowchart illustrating aspects of a method 2000 for creating and sharing combined content items in a shared content collection, in accordance with some examples. The method 2000 may be executed by various components of the interaction system 100, including for example the collection management system 224, the remix system 234 and the respective interaction client 104 instances on each user device.

The method 2000 commences at opening loop block 2002 and progresses to block 2004, where the interaction system 100 causes presentation of a content collection interface on a second user device associated with a second user of a media application (e.g., the interaction client 104). As mentioned above, the content collection interface enables the second user to navigate a shared content collection, including, for example, viewing a first content item created and shared by a first user (also being a member of the shared content collection).

The first user may have created the shared content collection. Accordingly, prior to block 2004, the method may include receiving, from a first user device of the first user, an indication of a first content collection sharing selection, with the first content collection sharing selection being associated with sharing the shared content collection between the first user and the second user. The first content collection sharing selection may include a user addition selection made by the first user to add the second user. As mentioned, the second user corresponds to a contact of the first user in the interaction system 100. Responsive to receiving the indication of the first content collection sharing selection, the collection management system 224 may store the shared content collection in association with the first user and the second user. As described above, in some examples, storing of the shared content collection in association with the first user and the second user may provide for the shared content collection to be editable and shareable by each of the first user and the second user. Specifically, this includes that the first user and the second user may each add new content items to the shared content collection and create “remixes” of eligible content items in the shared content collection.

The method 2000 includes, at block 2006, receiving, from the second user device, an indication of a first combination selection, the first combination selection being associated with the first content item. For example, the indication of the first combination selection may be selection of a combination graphical element by the second user (e.g., a remix button). The method 2000 proceeds to block 2008, where, responsive to receiving the indication of the first combination selection, the interaction system 100 accesses a second content item and enables the second user to combine the first content item with the second content item to create a first combined content item. The second user may then create the first combined content item and select to share it into the shared content collection, e.g., according to the examples described above.

At block 2010, the collection management system 224 receives an indication of a first content addition selection. The first content addition selection is associated with adding the first combined content item to the shared content collection. For example, this indication may include user selection of the continue button 1504 as described with reference to FIG. 15. Responsive to receiving the indication of the first content addition selection, the first combined content item is stored in association with the shared content collection (block 2012). (It will be appreciated that the first content item may have been added to the shared content collection by way of a second content addition selection, occurring before the first content addition selection and the “remixing” of the first content item. This stage may involve receiving, from the first user device, an indication of the second content addition selection, the second content addition selection being associated with adding the first content item to the shared content collection, and storing the first content item in association with the shared content collection.)

The first combined content item then becomes added to the shared content collection and a member, e.g., the first user, may request presentation of the shared content collection (e.g., via the first user device). At block 2014, the method 2000 includes causing presentation of the first combined content item within the content collection interface on the first user device associated with the first user. This allows the first user to view and interact with the combined content item created by the second user, based on the first user's original content item. The method 2000 then concludes at block 2016.

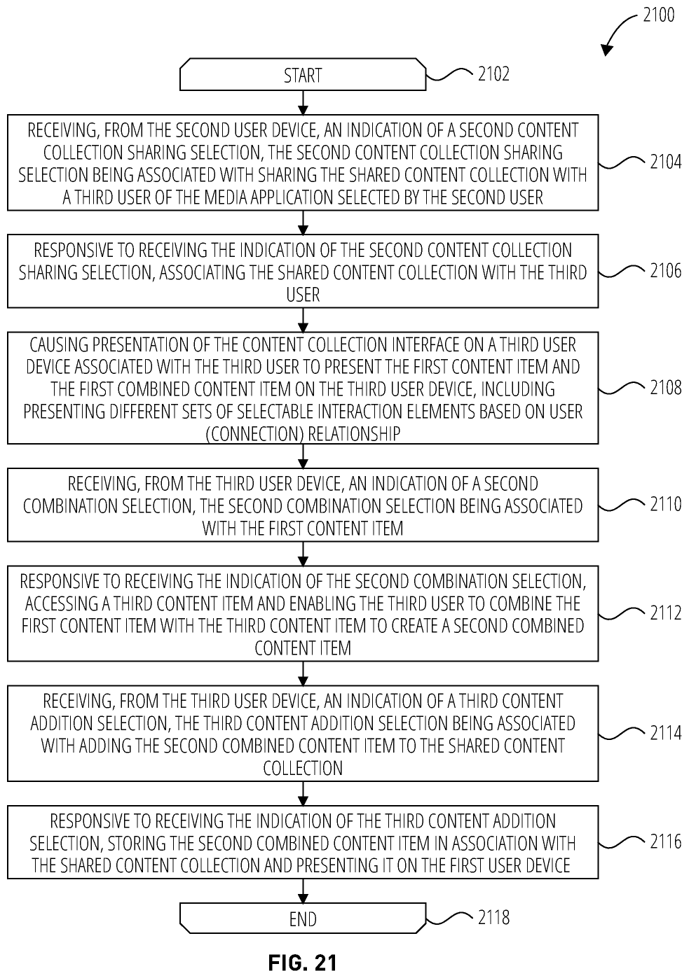

FIG. 21 is a flowchart illustrating aspects of a method 2100 for creating and sharing combined content items in a shared content collection, in accordance with some examples. The method 2100 may be executed by various components of the interaction system 100, including for example the collection management system 224, the remix system 234 and the respective interaction client 104 instances on each user device. The first user and the second user, referred to with reference to FIG. 20, are again referred to with reference to FIG. 21.

The method 2100 commences at opening loop block 2102 and proceeds to block 2104, where the collection management system 224 receives, from the second user device, an indication of a second content collection sharing selection. The second content collection sharing selection is associated with sharing the shared content collection with a third user of the media application selected by the second user. The third user is a contact (e.g., “friend”) of the second user, but not a contact of the first user, in the media application. In other words, the third user corresponds to a contact of the second user within the media application, and the third user does not correspond to a contact of the first user within the media application.

At block 2106, responsive to receiving the indication of the second content collection sharing selection, the shared content collection is associated with the third user. Associating the shared content collection with the third user provides for the shared content collection to be editable and shareable by the third user. Specifically, this includes that the third user may add new content items to the shared content collection and create “remixes” of eligible content items in the shared content collection.

Using the media application (e.g., the interaction client 104), at block 2108, presentation of the content collection interface is caused on a third user device associated with the third user to present the first content item and the first combined content item on the third user device. As mentioned above, different sets of selectable interaction elements may be presented for different viewed content items, based on user relationship. For example, if a viewing user and a creator of the viewed content item are friends, the interaction elements may include a reply option. If the viewing user and the creator are not friends, no reply option may be presented.

Accordingly, the method 2100 according to some examples may include identifying a first set of selectable interaction elements (e.g., including a reply graphical element) and a second set of selectable interaction elements (e.g., not including a reply graphical element), with the first set of selectable interaction elements being different from the second set of selectable interaction elements. The first set of selectable interaction elements may be presented within the content collection interface on a user device in conjunction with certain items, e.g., on the third user device in conjunction with the first combined content item (due to second user and the third user being contacts). The second set of selectable interaction elements may be presented within the content collection interface on a user device in conjunction with other items, e.g., on the third user device in conjunction with the first content item (due to the first user and the third user not being contacts).

The third user device transmits an indication of a second combination selection, associated with the first content item, at block 2110. In other words, the third user may also select to invoke the combination function in respect of the first content item (block 2110). “Remixing” of the first content item is merely an example, and it will be appreciated that the third user may also “remix” the first combined content item or another item in the shared content collection. Responsive to receiving the indication of the second combination selection, a third content item may be accessed, with the third user then being enabled to combine the first content item with the third content item to create a second combined content item, at block 2112.

At block 2114, the collection management system 224 receives, from the third user device, an indication of a third content addition selection. The third content addition selection is associated with adding the second combined content item to the shared content collection. In response to receiving the indication of the third content addition selection, at block 2116, the second combined content item is stored in association with the shared content collection such that it can then be presented to members of the shared content collection, e.g., on the first user device, at block 2116. Causing the presentation of a combined content item within the content collection interface on a user device may be responsive to receiving, from that user device, an indication of user input to request presentation of the shared content collection. The method 2100 then concludes at closing loop block 2118.

As mentioned, the third user may add one or more further users to the shared content collection. Accordingly, in some examples, the method 2100 may also include receiving, from the third user device, an indication of a third content collection sharing selection. The third content collection sharing selection is associated with sharing the shared content collection with a fourth user of the media application selected by the third user. The fourth user corresponds to a contact of the third user within the media application (and may or may not correspond to a contact of the first user and/or second user). Responsive to receiving the indication of the third content collection sharing selection, the collection management system 224 may associate the shared content collection with the fourth user.

Although the example methods 2000 and 2100 each depict a particular sequence of operations, the sequence/s may be altered without departing from the scope of the present disclosure. For example, some of the operations depicted may be performed in parallel or in a different sequence that does not materially affect the function of a process. In other examples, different components of an example device or system that implements a process may perform functions at substantially the same time or in a specific sequence.

System with Head-Wearable Apparatus

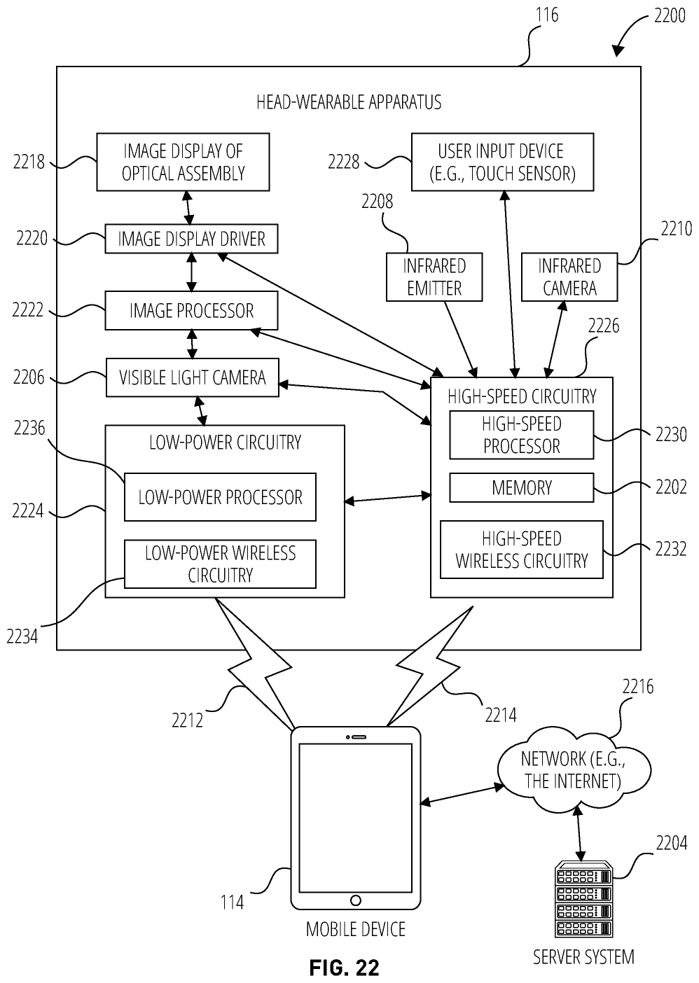

FIG. 22 illustrates a system 2200 including a head-wearable apparatus 116 with a selector input device, according to some examples. FIG. 22 is a high-level functional block diagram of an example head-wearable apparatus 116 communicatively coupled to a mobile device 114 and various server systems 2204 (e.g., the interaction server system 110) via various networks 108.

The head-wearable apparatus 116 includes one or more cameras, each of which may be, for example, a visible light camera 2206, an infrared emitter 2208, and an infrared camera 2210.

The mobile device 114 connects with head-wearable apparatus 116 using both a low-power wireless connection 2212 and a high-speed wireless connection 2214. The mobile device 114 is also connected to the server system 2204 and the network 2216.

The head-wearable apparatus 116 further includes two image displays of the image display of optical assembly 2218. The two image displays of optical assembly 2218 include one associated with the left lateral side and one associated with the right lateral side of the head-wearable apparatus 116. The head-wearable apparatus 116 also includes an image display driver 2220, an image processor 2222, low-power circuitry 2224, and high-speed circuitry 2226. The image display of optical assembly 2218 is for presenting images and videos, including an image that can include a graphical user interface to a user of the head-wearable apparatus 116.

The image display driver 2220 commands and controls the image display of optical assembly 2218. The image display driver 2220 may deliver image data directly to the image display of optical assembly 2218 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 2228 (e.g., touch sensor or push button), including an input surface on the head-wearable apparatus 116. The user input device 2228 (e.g., touch sensor or push button) is to receive from the user an input selection to manipulate the graphical user interface of the presented image.

The components shown in FIG. 22 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 2206 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 2202, which stores instructions to perform a subset or all of the functions described herein. The memory 2202 can also include storage device.

As shown in FIG. 22, the high-speed circuitry 2226 includes a high-speed processor 2230, a memory 2202, and high-speed wireless circuitry 2232. In some examples, the image display driver 2220 is coupled to the high-speed circuitry 2226 and operated by the high-speed processor 2230 in order to drive the left and right image displays of the image display of optical assembly 2218. The high-speed processor 2230 may be any processor capable of managing high-speed communications and operation of any general computing system needed for the head-wearable apparatus 116. The high-speed processor 2230 includes processing resources needed for managing high-speed data transfers on a high-speed wireless connection 2214 to a wireless local area network (WLAN) using the high-speed wireless circuitry 2232. In certain examples, the high-speed processor 2230 executes an operating system such as a LINUX operating system or other such operating system of the head-wearable apparatus 116, and the operating system is stored in the memory 2202 for execution. In addition to any other responsibilities, the high-speed processor 2230 executing a software architecture for the head-wearable apparatus 116 is used to manage data transfers with high-speed wireless circuitry 2232. In certain examples, the high-speed wireless circuitry 2232 is configured to implement Institute of Electrical and Electronic Engineers (IEEE) 802.11 communication standards, also referred to herein as WiFi. In some examples, other high-speed communications standards may be implemented by the high-speed wireless circuitry 2232.

The low-power wireless circuitry 2234 and the high-speed wireless circuitry 2232 of the head-wearable apparatus 116 can include short-range transceivers (Bluetooth™) and wireless wide, local, or wide area network transceivers (e.g., cellular or WiFi). Mobile device 114, including the transceivers communicating via the low-power wireless connection 2212 and the high-speed wireless connection 2214, may be implemented using details of the architecture of the head-wearable apparatus 116, as can other elements of the network 2216.

The memory 2202 includes any storage device capable of storing various data and applications, including, among other things, camera data generated by the left and right visible light cameras 2206, the infrared camera 2210, and the image processor 2222, as well as images generated for display by the image display driver 2220 on the image displays of the image display of optical assembly 2218. While the memory 2202 is shown as integrated with high-speed circuitry 2226, in some examples, the memory 2202 may be an independent standalone element of the head-wearable apparatus 116. In certain such examples, electrical routing lines may provide a connection through a chip that includes the high-speed processor 2230 from the image processor 2222 or the low-power processor 2236 to the memory 2202. In some examples, the high-speed processor 2230 may manage addressing of the memory 2202 such that the low-power processor 2236 will boot the high-speed processor 2230 any time that a read or write operation involving memory 2202 is needed.

As shown in FIG. 22, the low-power processor 2236 or high-speed processor 2230 of the head-wearable apparatus 116 can be coupled to the camera (visible light camera 2206, infrared emitter 2208, or infrared camera 2210), the image display driver 2220, the user input device 2228 (e.g., touch sensor or push button), and the memory 2202.

The head-wearable apparatus 116 is connected to a host computer. For example, the head-wearable apparatus 116 is paired with the mobile device 114 via the high-speed wireless connection 2214 or connected to the server system 2204 via the network 2216. The server system 2204 may be one or more computing devices as part of a service or network computing system, for example, that includes a processor, a memory, and network communication interface to communicate over the network 2216 with the mobile device 114 and the head-wearable apparatus 116.

The mobile device 114 includes a processor and a network communication interface coupled to the processor. The network communication interface allows for communication over the network 2216, low-power wireless connection 2212, or high-speed wireless connection 2214. Mobile device 114 can further store at least portions of the instructions for generating binaural audio content in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 2220. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 2204, such as the user input device 2228, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 2212 and high-speed wireless connection 2214 from the mobile device 114 via the low-power wireless circuitry 2234 or high-speed wireless circuitry 2232.

### Machine Architecture

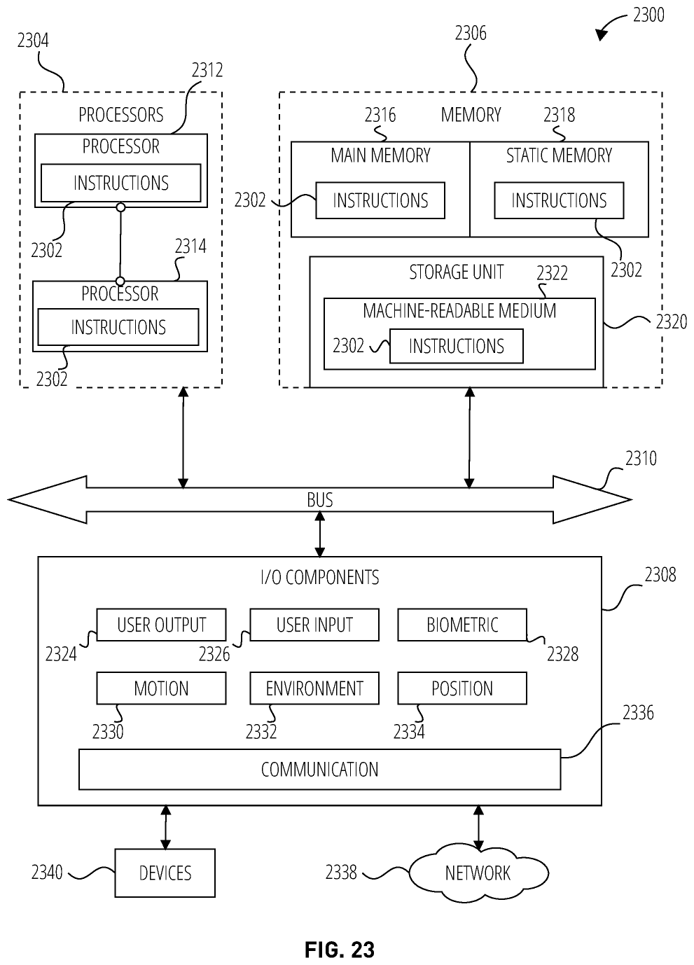

FIG. 23 is a diagrammatic representation of the machine 2300 within which instructions 2302 (e.g., software, a program, an application, an applet, an app, or other executable code) for causing the machine 2300 to perform any one or more of the methodologies discussed herein may be executed. For example, the instructions 2302 may cause the machine 2300 to execute any one or more of the methods described herein. The instructions 2302 transform the general, non-programmed machine 2300 into a particular machine 2300 programmed to carry out the described and illustrated functions in the manner described. The machine 2300 may operate as a standalone device or may be coupled (e.g., networked) to other machines. In a networked deployment, the machine 2300 may operate in the capacity of a server machine or a client machine in a server-client network environment, or as a peer machine in a peer-to-peer (or distributed) network environment. The machine 2300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2302, sequentially or otherwise, that specify actions to be taken by the machine 2300. Further, while a single machine 2300 is illustrated, the term “machine” shall also be taken to include a collection of machines that individually or jointly execute the instructions 2302 to perform any one or more of the methodologies discussed herein. The machine 2300, for example, may comprise the user system 102 or any one of multiple server devices forming part of the interaction server system 110. In some examples, the machine 2300 may also comprise both client and server systems, with certain operations of a particular method or algorithm being performed on the server-side and with certain operations of the particular method or algorithm being performed on the client-side.

The machine 2300 may include processors 2304, memory 2306, and input/output I/O components 2308, which may be configured to communicate with each other via a bus 2310. In an example, the processors 2304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 2312 and a processor 2314 that execute the instructions 2302. The term “processor” is intended to include multi-core processors that may comprise two or more independent processors (sometimes referred to as “cores”) that may execute instructions contemporaneously. Although FIG. 23 shows multiple processors 2304, the machine 2300 may include a single processor with a single-core, a single processor with multiple cores (e.g., a multi-core processor), multiple processors with a single core, multiple processors with multiples cores, or any combination thereof.

The memory 2306 includes a main memory 2316, a static memory 2318, and a storage unit 2320, both accessible to the processors 2304 via the bus 2310. The main memory 2306, the static memory 2318, and storage unit 2320 store the instructions 2302 embodying any one or more of the methodologies or functions described herein. The instructions 2302 may also reside, completely or partially, within the main memory 2316, within the static memory 2318, within machine-readable medium 2322 within the storage unit 2320, within at least one of the processors 2304 (e.g., within the processor's cache memory), or any suitable combination thereof, during execution thereof by the machine 2300.

The I/O components 2308 may include a wide variety of components to receive input, provide output, produce output, transmit information, exchange information, capture measurements, and so on. The specific I/O components 2308 that are included in a particular machine will depend on the type of machine. For example, portable machines such as mobile phones may include a touch input device or other such input mechanisms, while a headless server machine will likely not include such a touch input device. It will be appreciated that the I/O components 2308 may include many other components that are not shown in FIG. 23. In various examples, the I/O components 2308 may include user output components 2324 and user input components 2326. The user output components 2324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 2308 may include biometric components 2328, motion components 2330, environmental components 2332, or position components 2334, among a wide array of other components. For example, the biometric components 2328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2330 include acceleration sensor components (e.g., accelerometer), gravitation sensor components, rotation sensor components (e.g., gyroscope).

The environmental components 2332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 2334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2308 further include communication components 2336 operable to couple the machine 2300 to a network 2338 or devices 2340 via respective coupling or connections. For example, the communication components 2336 may include a network interface component or another suitable device to interface with the network 2338. In further examples, the communication components 2336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2340 may be another machine or any of a wide variety of peripheral devices (e.g., a peripheral device coupled via a USB).

Moreover, the communication components 2336 may detect identifiers or include components operable to detect identifiers. For example, the communication components 2336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2336, such as location via Internet Protocol (IP) geolocation, location via Wi-Fi® signal triangulation, location via detecting an NFC beacon signal that may indicate a particular location, and so forth.

The various memories (e.g., main memory 2316, static memory 2318, and memory of the processors 2304) and storage unit 2320 may store one or more sets of instructions and data structures (e.g., software) embodying or used by any one or more of the methodologies or functions described herein. These instructions (e.g., the instructions 2302), when executed by processors 2304, cause various operations to implement the disclosed examples.

The instructions 2302 may be transmitted or received over the network 2338, using a transmission medium, via a network interface device (e.g., a network interface component included in the communication components 2336) and using any one of several well-known transfer protocols (e.g., hypertext transfer protocol (HTTP)). Similarly, the instructions 2302 may be transmitted or received using a transmission medium via a coupling (e.g., a peer-to-peer coupling) to the devices 2340.

### Software Architecture

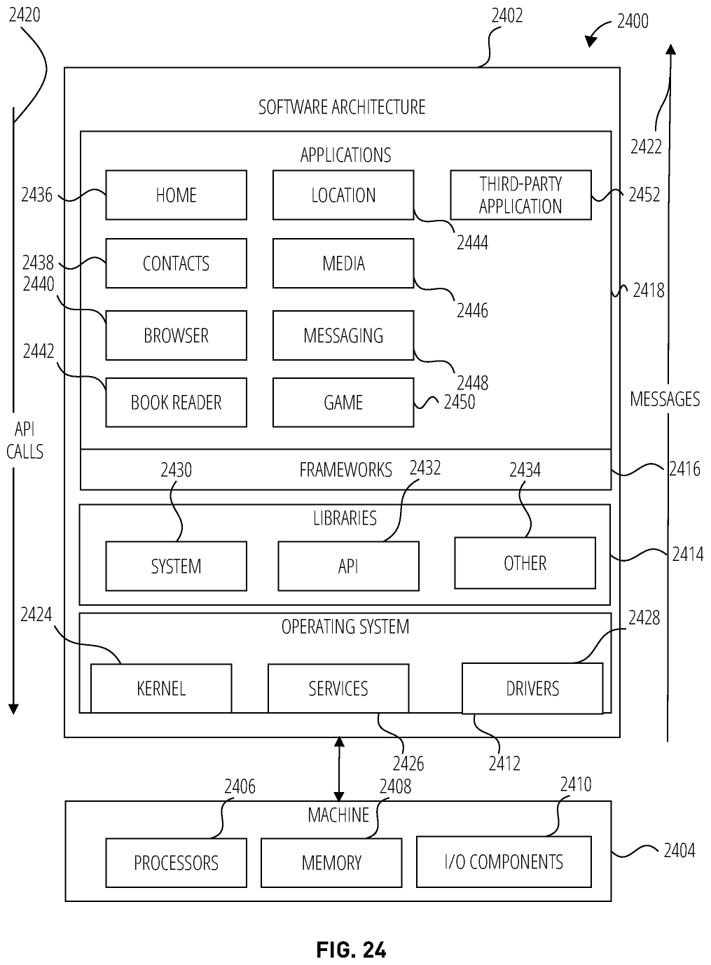

FIG. 24 is a block diagram 2400 illustrating a software architecture 2402, which can be installed on any one or more of the devices described herein. The software architecture 2402 is supported by hardware such as a machine 2404 that includes processors 2406, memory 2408, and I/O components 2410. In this example, the software architecture 2402 can be conceptualized as a stack of layers, where each layer provides a particular functionality. The software architecture 2402 includes layers such as an operating system 2412, libraries 2414, frameworks 2416, and applications 2418. Operationally, the applications 2418 invoke API calls 2420 through the software stack and receive messages 2422 in response to the API calls 2420.

The operating system 2412 manages hardware resources and provides common services. The operating system 2412 includes, for example, a kernel 2424, services 2426, and drivers 2428. The kernel 2424 acts as an abstraction layer between the hardware and the other software layers. For example, the kernel 2424 provides memory management, processor management (e.g., scheduling), component management, networking, and security settings, among other functionalities. The services 2426 can provide other common services for the other software layers. The drivers 2428 are responsible for controlling or interfacing with the underlying hardware. For instance, the drivers 2428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 2414 provide a common low-level infrastructure used by the applications 2418. The libraries 2414 can include system libraries 2430 (e.g., C standard library) that provide functions such as memory allocation functions, string manipulation functions, mathematic functions, and the like. In addition, the libraries 2414 can include API libraries 2432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2414 can also include a wide variety of other libraries 2434 to provide many other APIs to the applications 2418.

The frameworks 2416 provide a common high-level infrastructure that is used by the applications 2418. For example, the frameworks 2416 provide various graphical user interface (GUI) functions, high-level resource management, and high-level location services. The frameworks 2416 can provide a broad spectrum of other APIs that can be used by the applications 2418, some of which may be specific to a particular operating system or platform.

In an example, the applications 2418 may include a home application 2436, a contacts application 2438, a browser application 2440, a book reader application 2442, a location application 2444, a media application 2446, a messaging application 2448, a game application 2450, and a broad assortment of other applications such as a third-party application 2452. The applications 2418 are programs that execute functions defined in the programs. Various programming languages can be employed to create one or more of the applications 2418, structured in a variety of manners, such as object-oriented programming languages (e.g., Objective-C, Java, or C++) or procedural programming languages (e.g., C or assembly language). In a specific example, the third-party application 2452 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2452 can invoke the API calls 2420 provided by the operating system 2412 to facilitate functionalities described herein.

### Time-Based Access Architecture

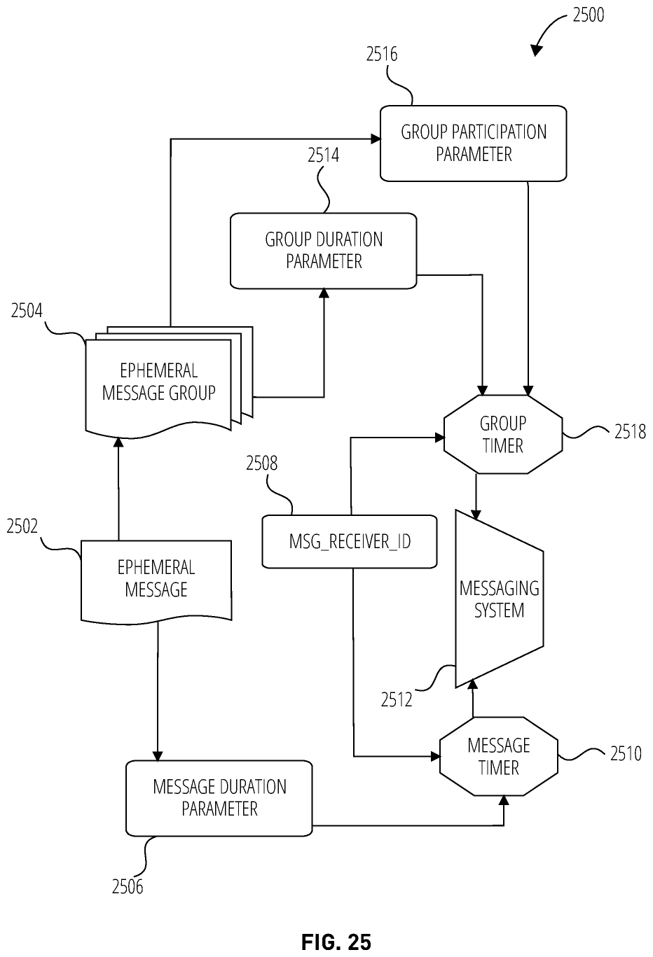

FIG. 25 is a schematic diagram illustrating an access-limiting process 2500, in terms of which access to content (e.g., an ephemeral message 2502 and associated multimedia payload of data) or a shared content collection (e.g., an ephemeral message group 2504) may be time-limited (e.g., made ephemeral).

An ephemeral message 2502 is shown to be associated with a message duration parameter 2506, the value of which determines the amount of time that the ephemeral message 2502 will be displayed to a receiving user of the ephemeral message 2502 by the interaction client 104. In some examples, an ephemeral message 2502 is viewable by a receiving user for up to a maximum of 10 seconds, depending on the amount of time that the sending user specifies using the message duration parameter 2506.

The message duration parameter 2506 and the message receiver identifier 2508 are shown to be inputs to a message timer 2510, which is responsible for determining the amount of time that the ephemeral message 2502 is shown to a particular receiving user identified by the message receiver identifier 2508. In particular, the ephemeral message 2502 will be shown to the relevant receiving user for a time period determined by the value of the message duration parameter 2506. The message timer 2510 is shown to provide output to a more generalized messaging system 2512, which is responsible for the overall timing of display of content (e.g., an ephemeral message 2502) to a receiving user.

The ephemeral message 2502 is shown in FIG. 25 to be included within an ephemeral message group 2504 (e.g., a collection of messages in a personal story, or an event story). The ephemeral message group 2504 has an associated group duration parameter 2514, a value of which determines a time duration for which the ephemeral message group 2504 is presented and accessible to users of the interaction system 100. The group duration parameter 2514, for example, may be the duration of a music concert, where the ephemeral message group 2504 is a collection of content pertaining to that concert. Alternatively, a user (either the owning user or a curator user) may specify the value for the group duration parameter 2514 when performing the setup and creation of the ephemeral message group 2504.

Additionally, each ephemeral message 2502 within the ephemeral message group 2504 has an associated group participation parameter 2516, a value of which determines the duration of time for which the ephemeral message 2502 will be accessible within the context of the ephemeral message group 2504. Accordingly, a particular ephemeral message group 2504 may “expire” and become inaccessible within the context of the ephemeral message group 2504 prior to the ephemeral message group 2504 itself expiring in terms of the group duration parameter 2514. The group duration parameter 2514, group participation parameter 2516, and message receiver identifier 2508 each provide input to a group timer 2518, which operationally determines, firstly, whether a particular ephemeral message 2502 of the ephemeral message group 2504 will be displayed to a particular receiving user and, if so, for how long. Note that the ephemeral message group 2504 is also aware of the identity of the particular receiving user as a result of the message receiver identifier 2508.

Accordingly, the group timer 2518 operationally controls the overall lifespan of an associated ephemeral message group 2504 as well as an individual ephemeral message 2502 included in the ephemeral message group 2504. In some examples, each and every ephemeral message 2502 within the ephemeral message group 2504 remains viewable and accessible for a time period specified by the group duration parameter 2514. In a further example, a certain ephemeral message 2502 may expire within the context of ephemeral message group 2504 based on a group participation parameter 2516. Note that a message duration parameter 2506 may still determine the duration of time for which a particular ephemeral message 2502 is displayed to a receiving user, even within the context of the ephemeral message group 2504. Accordingly, the message duration parameter 2506 determines the duration of time that a particular ephemeral message 2502 is displayed to a receiving user regardless of whether the receiving user is viewing that ephemeral message 2502 inside or outside the context of an ephemeral message group 2504.

The messaging system 2512 may furthermore operationally remove a particular ephemeral message 2502 from the ephemeral message group 2504 based on a determination that it has exceeded an associated group participation parameter 2516. For example, when a sending user has established a group participation parameter 2516 of 24 hours from posting, the messaging system 2512 will remove the relevant ephemeral message 2502 from the ephemeral message group 2504 after the specified 24 hours. The messaging system 2512 also operates to remove an ephemeral message group 2504 when either the group participation parameter 2516 for each and every ephemeral message 2502 within the ephemeral message group 2504 has expired, or when the ephemeral message group 2504 itself has expired in terms of the group duration parameter 2514.

In certain use cases, a creator of a particular ephemeral message group 2504 may specify an indefinite group duration parameter 2514. In this case, the expiration of the group participation parameter 2516 for the last remaining ephemeral message 2502 within the ephemeral message group 2504 will determine when the ephemeral message group 2504 itself expires. In this case, a new ephemeral message 2502, added to the ephemeral message group 2504, with a new group participation parameter 2516, effectively extends the life of an ephemeral message group 2504 to equal the value of the group participation parameter 2516.

Responsive to the messaging system 2512 determining that an ephemeral message group 2504 has expired (e.g., is no longer accessible), the messaging system 2512 communicates with the interaction system 100 (and, for example, specifically the interaction client 104) to cause an indicium (e.g., an icon) associated with the relevant ephemeral message group 2504 to no longer be displayed within a user interface of the interaction client 104. Similarly, when the messaging system 2512 determines that the message duration parameter 2506 for a particular ephemeral message 2502 has expired, the messaging system 2512 causes the interaction client 104 to no longer display an indicium (e.g., an icon or textual identification) associated with the ephemeral message 2502.

### CONCLUSION

Disclosed examples thus provide for an interaction system that allows a user to create a content collection including one or more content items. The interaction system provides for the user to share the content collection with one or more other users. The one or more other users may also share the content collection with one or more further users (not necessarily being connected to the original user (creator of the collection)). In this way, each user is associated with the content collection.

By virtue of being associated with the shared content collection, each user may be able to view the content collection, to add content to the content collection, and to perform other actions as described herein. The content may include a combined content item created by one of the users, e.g., using an existing content item in the shared content collection as a base item. The interaction system may enable such combined content items to be shared and even to be further combined (“remixed”).

An example technical problem of providing new sharing options, e.g., enabling a user to react to, or creatively interact with, a content item shared by a third party who is not necessarily a contact of the user, without requiring a reply option, may be addressed via shared content collection and content combination functionality. A technical problem of reducing computational resources/processing power associated with having to perform certain workarounds and/or improving attributing media content to creators (including notifying creators of interactions with their content) may also be addressed.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

The terms “combined” and “combination”, e.g., when used to refer to combined content items and/or a combination function, refer to content items or content data that have been, or may be, combined in any suitable manner. Examples may include combinations of two or more images, combinations of two or more video clips, or the like. Examples may also include combinations of different content types, e.g., a video clip combined with a still image, combinations of video and audio data such as a video clip combined with an audio clip, or combinations thereof. Combinations may be arranged in different ways, e.g., items may be displayed or played concurrently, sequentially, or in an overlapping fashion, and items may be arranged using different layout options, e.g., overlays, split screens, image in image, or the like, with examples being described herein.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A method to facilitate combination of content items in a shared content collection, the shared content collection being shared between a first user and a second user, the method comprising:
causing presentation of a content collection interface on a second user device associated with the second user, the content collection interface enabling the second user to navigate the shared content collection, and the shared content collection comprising at least a first content item;
receiving, from the second user device, an indication of a first combination selection to invoke a combination function, the first combination selection being associated with the first content item;
responsive to receiving the indication of the first combination selection, accessing a second content item and enabling the second user to create a first combined content item by combining the first content item with the second content item;
receiving, from the second user device, an indication of a first content addition selection to add the first combined content item to the shared content collection;
responsive to receiving the indication of the first content addition selection, storing the first combined content item in association with the shared content collection; and
causing presentation of the first combined content item within the content collection interface on a first user device associated with the first user.

2. The method of claim 1, comprising:
receiving, from the first user device, an indication of a second content addition selection to add the first content item to the shared content collection, the first user having created the first content item using a media application; and
responsive to receiving the indication of the second content addition selection, storing the first content item in association with the shared content collection.

3. The method of claim 1, comprising:
receiving, from the first user device, an indication of a first content collection sharing selection to share the shared content collection between the first user and the second user, the first content collection sharing selection including a user addition selection made by the first user to add the second user, the second user corresponding to a contact of the first user within a media application; and
responsive to receiving the indication of the first content collection sharing selection, storing the shared content collection in association with the first user and the second user.

4. The method of claim 3, wherein the storing of the shared content collection in association with the first user and the second user provides for the shared content collection to be editable and shareable by each of the first user and the second user.

5. The method of claim 3, comprising:
receiving, from the second user device, an indication of a second content collection sharing selection to share the shared content collection with a third user of the media application selected by the second user, the third user corresponding to a contact of the second user within the media application, and the third user not corresponding to a contact of the first user within the media application;
responsive to receiving the indication of the second content collection sharing selection, associating the shared content collection with the third user; and
causing presentation of the content collection interface on a third user device associated with the third user to present the first content item and the first combined content item on the third user device.

6. The method of claim 5, wherein the associating of the shared content collection with the third user provides for the shared content collection to be editable and shareable by the third user.

7. The method of claim 5, comprising:
identifying a first set of selectable interaction elements and a second set of selectable interaction elements, the first set of selectable interaction elements being different from the second set of selectable interaction elements;
presenting the first set of selectable interaction elements within the content collection interface on the third user device in conjunction with the first combined content item; and
presenting the second set of selectable interaction elements within the content collection interface on the third user device in conjunction with the first content item.

8. The method of claim 7, wherein the first set of selectable interaction elements includes a reply graphical element and the second set of selectable interaction elements does not include the reply graphical element.

9. The method of claim 5, comprising:
receiving, from the third user device, an indication of a second combination selection to invoke the combination function, the second combination selection being associated with the first content item;
responsive to receiving the indication of the second combination selection, accessing a third content item and enabling the third user to create a second combined content item by combining the first content item with the third content item;
receiving, from the third user device, an indication of a third content addition selection to add the second combined content item to the shared content collection;
responsive to receiving the indication of the third content addition selection, storing the second combined content item in association with the shared content collection; and
causing presentation of the second combined content item within the content collection interface on the first user device.

10. The method of claim 9, wherein causing the presentation of the second combined content item within the content collection interface on the first user device is responsive to receiving, from the first user device, an indication of user input to request presentation of the shared content collection.

11. The method of claim 1, wherein the shared content collection is created by the first user.

12. The method of claim 1, wherein the shared content collection comprises a set of content items, including the first content item and the first combined content item, the content collection interface providing a sequential presentation of the set of content items.

13. The method of claim 1, wherein accessing the second content item and enabling the second user to create the first combined content item comprises invoking the combination function on the second user device, the combination function being a combination function of a media application and including a camera function that enables the second user to select the second content item.

14. The method of claim 13, wherein the camera function includes a modular camera function, the modular camera function providing an augmentation carousel comprising a plurality of user-selectable lens elements.

15. The method of claim 1, comprising causing presentation, on the second user device, of a combination graphical element, wherein the indication of the first combination selection includes an indication of user selection, by the second user, of the combination graphical element.

16. The method of claim 15, wherein the combination graphical element comprises a camera indicium and a graphical component that identifies the combination function, the camera indicium and the graphical component caused to be displayed in conjunction with the first content item within the content collection interface on the second user device.

17. The method of claim 1, wherein accessing the second content item and enabling the second user to create the first combined content item comprises invoking the combination function, the combination function being a combination function of a media application and including a layout function to enable the second user to specify a layout relationship of the first content item relative to the second content item during presentation of the first combined content item.

18. The method of claim 5, comprising:
receiving, from the third user device, an indication of a third content collection sharing selection to share the shared content collection with a fourth user of the media application selected by the third user, the fourth user corresponding to a contact of the third user within the media application; and
responsive to receiving the indication of the third content collection sharing selection, associating the shared content collection with the fourth user.

19. A computing apparatus comprising:
a processor; and
a memory storing instructions that, when executed by the processor, configure the apparatus to perform operations to facilitate combination of content items in a shared content collection, the shared content collection being shared between a first user and a second user, the operations comprising:
causing presentation of a content collection interface on a second user device associated with the second user, the content collection interface enabling the second user to navigate the shared content collection, and the shared content collection comprising at least a first content item;
receiving, from the second user device, an indication of a first combination selection to invoke a combination function, the first combination selection being associated with the first content item;
responsive to receiving the indication of the first combination selection, accessing a second content item and enabling the second user to create a first combined content item by combining the first content item with the second content item;
receiving, from the second user device, an indication of a first content addition selection to add the first combined content item to the shared content collection;
responsive to receiving the indication of the first content addition selection, storing the first combined content item in association with the shared content collection; and
causing presentation of the first combined content item within the content collection interface on a first user device associated with the first user.

20. A non-transitory computer-readable storage medium, the computer-readable storage medium including instructions that when executed by a computer, cause the computer to perform operations to facilitate combination of content items in a shared content collection, the shared content collection being shared between a first user and a second user, the operations comprising:
causing presentation of a content collection interface on a second user device associated with the second user, the content collection interface enabling the second user to navigate the shared content collection, and the shared content collection comprising at least a first content item;
receiving, from the second user device, an indication of a first combination selection to invoke a combination function, the first combination selection being associated with the first content item;
responsive to receiving the indication of the first combination selection, accessing a second content item and enabling the second user to create a first combined content item by combining the first content item with the second content item;
receiving, from the second user device, an indication of a first content addition selection to add the first combined content item to the shared content collection;
responsive to receiving the indication of the first content addition selection, storing the first combined content item in association with the shared content collection; and
causing presentation of the first combined content item within the content collection interface on a first user device associated with the first user.
